(19) United States
(12) Patent Application Publication
(10) Pub. No.: US 2009/0277333 A1
(43) Pub. Date: Nov. 12, 2009

(54) Oxygen concentrating device

(76) Inventors: Hideyuki Sakurai, Okayama (JP); Noboru Watanabe, Okayama (JP)

Correspondence Address: QUINN EMANUEL;KODA & ANDROLIA, 865 S. FIGUEROA STREET, 10TH FLOOR, LOS ANGELES, CA, 90017, US

(21) Appl. No.: 12/308,964

(22) PCT Filed: Jul. 2, 2007
(86) PCT No.: PCT/JP2007/063247

§ 371 Date: Dec. 30, 2008

(30) Foreign Application Priority Data
Jul. 3, 2006 (JP) 2006-183880
Feb. 23, 2007 (JP) 2007-044158

(51) Int. Cl. B03C 1/0355

(52) U.S. Cl. 96/150; 96/154

(57) ABSTRACT

An oxygen concentrating device easy to assemble and able to reduce production costs. The oxygen concentrating device (101) comprises a plurality of components including an adsorbing column (102) storing adsorbent capable of selectively adsorbing nitrogen contained in material air, a storing tank (103) for temporarily storing concentrated oxygen gas generated in the adsorbing column (102), a gas transferring means (104) for transferring material air, concentrated oxygen gas or exhaust gas, a solenoid valve (106) for opening/closing or switching a gas flow path connected to the adsorbing column (102), and a control means (108) for controlling the gas transferring means and/or the solenoid valve, resin supports (109) for positioning and supporting the plurality of components at predetermined locations, and a plurality of resin covers (110) covering the outer sides of the supports (109), the supports (109) being formed by injection molding.

### TECHNICAL FIELD

The present invention relates to an oxygen concentrating device for generating a concentrated oxygen gas with increased oxygen concentration. In particular, it relates to a medical oxygen concentrating device for supplying concentrated oxygen gas to a patient with respiratory system illness such as lung emphysema and bronchitis.

### BACKGROUND ART

An oxygen inhalation therapy is known as a method effective in treating respiratory system illness such as lung emphysema and bronchitis. The oxygen inhalation therapy alleviates pain and suffering that patients feel such as difficulty in breathing, by supplying oxygen to tissue cells lacking oxygen by making patients inhale the concentrated oxygen gas and maintaining the function of the tissue cells. In Japan, health insurance started to be applied even to oxygen inhalation therapy at home, and patients being treated with oxygen inhalation therapy at home increased from 1985. In view of such actual situation, the demand for a medical oxygen concentrating device capable of generating concentrated oxygen gas from the circumambient air and supplying the same to the patient is steadily increasing.

The type of the medical oxygen concentrating device varies, but is roughly divided into a pressure fluctuation adsorbing type of generating the concentrated oxygen gas using an adsorbent capable of selectively adsorbing nitrogen contained in the circumambient air (material air), and a separation film type of obtaining the concentrated oxygen gas using an oxygen permeating membrane. However, the medical oxygen concentrating device of the pressure fluctuation adsorbing type come into the mainstream in recent years from the reason that the concentrated oxygen gas with high oxygen concentration is easy to obtain.

A general medical oxygen concentrating device of the pressure fluctuation adsorbing type includes an adsorbing column storing adsorbent capable of selectively adsorbing nitrogen contained in the material air; a storing tank for temporarily storing the concentrated oxygen gas generated in the adsorbing column; a gas transferring means for transferring material air, concentrated oxygen gas or exhaust gas; an solenoid valve for opening/closing or switching a gas flow path connected to the adsorbing column; and a control means for controlling each part (e.g., patent document 1). This type of medical oxygen concentrating device generates the concentrated oxygen gas by alternately switching an adsorbing process of adsorbing the nitrogen contained in the material air to the adsorbent by raising the pressure of the adsorbing column, and a reproducing process of desorbing the nitrogen adsorbed to the adsorbent by lowering the pressure of the adsorbing column.

This type of medical oxygen concentrating device is small and easy to use, and is suited for oxygen inhalation therapy at home, but is configured by numerous components such as the adsorbing column, the storing tank, the gas transferring means, the solenoid valve, and the control means and thus requires work to assemble such components. In particular, a lot of work is required for the task of bolt fixing each component at a deep position on the inner side of a cover. The production cost of the medical oxygen concentrating device also may increase since the dimensional tolerance and the like of the bolt hole formed in each component needs to be suppressed small.

Furthermore, this type of medical oxygen concentrating device uses components that generate noise such as gas transferring means and solenoid valve, and thus soundproof measures need to be sufficiently considered so as to be comfortably used to perform oxygen inhalation therapy at home. In view of such actual situation, the housing of the oxygen concentrating device may be formed with a soundproof raw material such as wood (e.g., patent document 2), but if the housing is made of wood, not only reduction of the production cost of the oxygen concentrating device, but also reduction in weight becomes difficult.

Furthermore, this type of medical oxygen concentrating device adopts a mode of compressing the material air and transferring to the adsorbing column with the gas transferring means such as a compressor, or transferring the exhaust gas from the adsorbing column with the gas transferring means such as a vacuum pump, and a structure is such that vibration generated in such gas transferring means easily leaks to the outside as noise. The compressor is normally incorporated in a state accommodated in a box body called a compressor box, but noise is still difficult to suppress. The vibration that becomes the cause of noise also generates from other components such as solenoid valve and adsorbing column. In order to promote wide use of the medical oxygen concentrating device, the vibration generated in such components is desirably absorbed to reduce the noise.

Moreover, since this type of medical oxygen concentrating device is configured by numerous components such as the adsorbing column, the storing tank, the gas transferring means, the solenoid valve, the control means, or the like, work is required to assemble such components. In particular, a lot of work is required for the task of bolt fixing each component at a deep position on the inner side of a cover. The production cost of the medical oxygen concentrating device also may increase since the dimensional tolerance and the like of the bolt hole formed in each component needs to be suppressed small.

A chassis of a device configured by a support made of foam resin formed with a plurality of concave parts for accommodating and supporting a plurality of components, and a cover for accommodating the support has already been proposed (see e.g., patent document 3 and patent document 4). It is said that the number of components configuring the chassis of the device can be greatly reduced, and furthermore, the dimensional tolerance of the component supported by the support can be increased. Moreover, it is said that assembly of the components to the support can be facilitated, the noise leaking to the outer side of the cover can be suppressed, and the components supported by the support can be protected from impact.

However, the chassis of the device described in patent document 3 and patent document 4 is not necessarily suited for accommodating components that involve a relatively heavy and strong vibration such as compressor. This is because if the compressor is accommodated in the chassis of the device, the noise or rattling may generate from a contacting portion of the support made of foam resin and the compressor or the compressor box. Actually, the chassis of the device aims to accommodate components that do not involve strong vibration such as circuit substrate and storage disk, and using such chassis in a device equipped with components that involve a relatively heavy and strong vibration such as compressor is not described in patent document 3 and patent document 4.

[Patent document 1] JJP 2005-058469 A

[Patent document 2] JP 07-275632 A

[Patent document 3] JP 3362888 B

[Patent document 4] JP 3473905 B

### DISCLOSURE OF THE INVENTION

### Problems to be Solved by the Invention

In view of solving the above problems, the present invention provides an oxygen concentrating device in which assembly is easy and the production cost can be reduced. Another object of the present invention is to provide an oxygen concentrating device having an excellent outer appearance in which dimensional precision is high, and furthermore, shrinkage hole (depression formed on a surface side etc. of a reinforcement rib to be hereinafter described) and taper (inclination formed on the support to facilitate separation from a die in injection molding) of the support are not outstanding. Furthermore, another object of the present invention is to provide an oxygen concentrating device in which lighter weight is facilitated.

Still further, an oxygen concentrating device in which assembly of components is easy, and the troubles in production and maintenance can be reduced is provided. In addition, another object of the present invention is to provide an oxygen concentrating device capable of not only protecting components from impact, but also capable of absorbing vibration of the components and alleviating the noise.

### Means for Solving the Problem

The above problem is resolved by providing an oxygen concentrating device configured by a plurality of components including an adsorbing column storing an adsorbent capable of selectively adsorbing nitrogen contained in material air, a storing tank for temporarily storing concentrated oxygen gas generated in the adsorbing column, a gas transferring means for transferring the material air, the concentrated oxygen gas or exhaust gas, a solenoid valve for opening, closing or switching a gas flow path connected to the adsorbing column, and a control means for controlling the gas transferring means and/or the solenoid valve; wherein a support made of resin positioning and supporting the plurality of components at predetermined locations, and a plurality of covers made of resin for covering the outer sides of the support are arranged, the support being formed by injection molding.

Thus, the assembly of the oxygen concentrating device is facilitated, and the production cost thereof is reduced. The dimensional accuracy of the support can be enhanced by injection molding the support. Furthermore, shrinkage hole (depression formed on a surface side etc. of a reinforcement rib to be hereinafter described) and taper (inclination formed on the support to facilitate separation from a die in injection molding) of the support are covered with the cover, so that the outer appearance of the oxygen concentrating device can be enhanced. Moreover, reduction in weight of the oxygen concentrating device is facilitated. In addition, segregation when discarding the oxygen concentrating device can be easily performed by forming the support and the cover by resin instead of wood.

An air take-in port filter for removing dust coexisting in air taken into the inner side of the cover, and a filter cover for covering the outer sides of the air take-in port filter are arranged; wherein a filter cover attachment part for removably attaching the filter cover is preferably arranged on the cover. Thus, the air take-in port filter for removing dust coexisting in the air taken into the inner side of the cover can be easily detached, and maintenance of the oxygen concentrating device such as replacement and cleaning of the air take-in port filter can be easily carried out.

The support is preferably integrally formed by a bottom plate, a pair of side plates upstanding perpendicularly from both side edges of the bottom plate, and a partition plate for partitioning a space sandwiched by the pair of side plates to front and back. Thus, the support is not only easy to assemble the plurality of components, but also excels in strength. The noise emitted towards the front from the oxygen concentration device can be reduced by arranging the components that emit a relatively large noise such as gas transferring means on the back side than the partition plate.

Preferably, a fit-in part for positioning and fixing the plurality of covers with respect to the support is arranged on the plurality of covers and the support, respectively. Thus, the cover can be fixed to the support without using fixtures such as screw, and the assembly of the oxygen concentrating device can be further facilitated.

The molding method of the cover is not particularly limited, but is preferably injection molded. The production cost of the oxygen concentrating device is reduced, and furthermore, the weight of the oxygen concentrating device becomes lighter. The dimensional accuracy of the cover can also be enhanced.

The same type of resin may be used for the support and the cover, but different types of resin are preferably used according to the required performance. The resin suitably used for the support and the cover includes ABS resin, polypropylene, polystyrene, AS resin, polyvinyl chloride, acryl resin, polybutylene terephthalate, polyamide, polyacetal, polycarbonate, and the like. Among them, the support requiring strength is preferably made of ABS resin, and the cover not requiring strength and rigidity as much is preferably made of polypropylene having flexibility with respect to impact from the outside. The production cost then can be suppressed while enhancing the strength and the rigidity of the oxygen concentrating device. The cover is then less likely to change color.

Casters are preferably arranged at a bottom of the support. Thus, the oxygen concentrating device can be easily moved.

A reinforcement rib is preferably arranged on the support and/or the cover. The strength of the oxygen concentrating device then can be enhanced. The reinforcement rib can be easily formed when injection molding the support and the cover.

Preferably, an adsorbing column holder for holding the adsorbing column is arranged, an adsorbing column holder insertion part for inserting the adsorbing column holder being arranged in the support. The adsorbing column then can be securely supported by the support without using screw and the like. Therefore, the task and man-hour in assembling the oxygen concentrating device and in replacing the adsorbing column can be reduced.

In the present invention, at least one of the components of the adsorbing column, the gas transferring means, the storing tank, or the solenoid valve is preferably supported by the support by way of a cushion material.

An oxygen concentrating device in which the assembly of the components is easy and the trouble in production and maintenance is reduced is thereby provided. Furthermore, not only are the components protected from impact, but the vibration of the components can be absorbed thereby reducing the noise emitted from the oxygen concentrating device.

The components applying the cushion material may be any one of the adsorbing column, the gas transferring means, the storing tank, or the solenoid valve. However, among such components, the gas transferring means and the solenoid valve tend to generate strong vibration and emit large noise. Thus, the cushion material is preferably used for at least one (particularly gas transferring means) of the gas transferring means or the solenoid valve, and the cushion material is more preferably used for both the gas transferring means and the solenoid valve.

The gas transferring means may be directly covered with the cushion material, but preferably, the gas transferring means is accommodated in the metal gas transferring means accommodation box, and the gas transferring means accommodation box is supported by the support by way of the cushion material. The noise emitted from the gas transferring means then can be shielded by the gas transferring means accommodation box, and the noise emitted from the oxygen concentrating device can be further reduced. The vibration absorption measure for suppressing the vibration of the gas transferring means accommodated inside is normally applied to the gas transferring means accommodation box. The vibration absorption measure includes arranging the gas transferring means on the floor of the gas transferring means accommodation box by way of a vibration absorption means such as spring or rubber, or suspending the gas transferring means from the ceiling. The sound absorbing material for absorbing noise emitted from the gas transferring means is normally arranged on the inner surface of the gas transferring means accommodation box.

Preferably, the gas transferring means is arranged on a gas flow path on a material air introducing side of the adsorbing column; and a sound deadening tank is arranged in each of a gas flow path on a material air introducing side of the gas transferring means, a gas flow path on a material air exporting side of the gas transferring means, and a gas flow path on an exhaust gas exporting side of the adsorbing column, at least one of the sound deadening tanks being accommodated in the gas transferring means accommodation box. Thus, the noise emitted from the oxygen concentrating device can be further reduced. In particular, the sound deadening tank arranged on the gas flow path on the material air exporting side of the gas transferring means is preferably accommodated in the gas transferring means accommodation box. Since the material air exported from the gas transferring means is compressed and the temperature rises, the temperature of the sound deadening tank arranged on the gas flow path on the material air exporting side of the gas transferring means tends to rise, but such sound deadening tank can be cooled together with the gas transferring means by the cooling fan, to be hereinafter described, by being accommodated in the gas transferring means accommodation box together with the gas transferring means.

The material of the cushion material is not particularly limited, but is preferably a fiber assembly. The cushion material thus excels not only in buffer property, but also in sound absorbing property. The form of the cushion material is also not particularly limited, but is preferably in a sheet form. The components then can be wrapped with the cushion material regardless of their form. Among them, the non-woven cloth having a thickness of between 2 and 50 mm is suitable for the cushion material. The thickness of the non-woven cloth is defined as the thickness under the load of 0.002 psi.

A sound absorbing material is preferably arranged on an inner surface of the cover in the above-described oxygen concentrating device. Thus, the noise emitted from each component is less likely to leak out to the outer side of the cover. The material forming the sound absorbing material is not particularly limited, and may be resin foam or fiber assembly. Among them, the resin foam is preferable as it is easy to mold, and gives strength to the cover.

The sound absorbing material preferably contacts each component (in particular, gas transferring means that easily rattles, adsorbing column having large dimension) accommodated on the inner side of the cover. The rattling of each component accommodated on the inner side of the cover then can be prevented, and furthermore, the overall strength of the cover can be increased, and the deformation of the surface of the cover can be prevented.

In the oxygen concentrating device, the support preferably functions as a partition plate for partitioning an inner side of the cover to the front and the back, at least one of components of the gas transferring means or the solenoid valve being arranged on the back side than the support. The noise emitted from the front surface side of the oxygen concentrating device can be further reduced by arranging components that emit a relatively large noise on the back side than the support. The support is preferably a plastic molded article.

Preferably, the support includes a solenoid valve accommodation chamber for accommodating the solenoid valve, a control means accommodation chamber for accommodating the control means, and a gas transferring means accommodation chamber for accommodating the gas transferring means. The solenoid valve, the control means, and the gas transferring means then can be reliably supported by the support.

Preferably, a cooling fan for transferring cold air is arranged on an inner side of the cover; wherein the solenoid valve accommodation chamber, the control means accommodation chamber, and the gas transferring means accommodation chamber are communicated, so that the cold air is supplied to the solenoid valve accommodation chamber, the control means accommodation chamber, and the gas transferring means accommodation chamber by the cooling fan. The components that easily self-heat such as the gas transferring means and the control means, as well as the components that easily accumulate heat such as the solenoid valve then can be cooled.

Preferably, the solenoid valve or the control means are arranged on an upstream side in a cold air flowing direction than the cooling fan, and the gas transferring means having a large heat generation amount compared to the solenoid valve and the control means is arranged on a downstream side in the cold air flowing direction than the cooling fan. Thus, in particular, the gas transferring means that self-heats can be mainly cooled. If the solenoid valve is arranged on the downstream side in the cold air flowing direction than the gas transferring means, the cold air become high temperature that cooled the gas transferring means is blown against the solenoid valve, which may raise the temperature of the solenoid valve, and thus such disadvantage can be resolved. In particular, the solenoid valve can be efficiently cooled if the solenoid valve is arranged on the upstream side in the cold air flowing direction than the cooling fan. Since the cause of temperature rise of the solenoid valve is barely by self-heating, and mainly by heat transferred from the gas transferring means through the material air, the concentrated oxygen gas, the exhaust gas and the like, cooling the gas transferring means leads to cooling the solenoid valve.

The above problem is also resolved by providing an oxygen concentrating device in which a plurality of components including an adsorbing column storing an adsorbent capable of selectively adsorbing nitrogen contained in material air, a storing tank for temporarily storing concentrated oxygen gas generated in the adsorbing column, a gas transferring means for transferring the material air, the concentrated oxygen gas or exhaust gas, a solenoid valve for opening/closing or switching a gas flow path connected to the adsorbing column, and a control means for controlling the gas transferring means and/or the solenoid valve is subjected to wiring and/or piping, and then covered with a cover, wherein an intake filter for removing dust coexisting in the material air supplied to the adsorbing column, and a filter holder for holding the intake filter are arranged, an opening A for inserting and removing the filter holder being formed in the cover. Thus, the intake filter can be detached without detaching the cover, and maintenance of the oxygen concentrating device such as replacement and cleaning of the intake filter can be easily carried out.

Preferably, a support for positioning and supporting the plurality of components at predetermined locations is arranged on an inner side of the cover, wherein an opening B is formed in the support, and the filter holder is inserted and removed from the outer side of the cover through the opening A and the opening B. Thus, the rattling of the plurality of components can be prevented without making the maintenance of the intake filter hard.

### EFFECTS OF THE INVENTION

As mentioned above, an oxygen concentrating device in which the assembly is facilitated and the production cost can be reduced is provided according to the present invention. An oxygen concentrating device in which, in addition to increase in the dimensional accuracy, shrinkage hole (depression formed on a surface side etc. of a reinforcement rib to be hereinafter described) and taper (inclination formed on the support to facilitate separation from a die in injection molding) of the support are less outstanding, and has an excellent outer appearance can be provided.

When the cushion material is used, an oxygen concentrating device in which the assembly of the components is facilitated, and the trouble in production and maintenance is reduced is thereby provided. An oxygen concentrating device that not only protects the components from impact, but absorbs vibration of the components and reduces noise can be also provided.

### BRIEF DESCRIPTION OF THE DRAWINGS

FIG. 1 is a perspective view illustrating a state of an oxygen concentrating device of a first embodiment of the present invention seen from the front side;

FIG. 2 is a perspective view illustrating a state of the oxygen concentrating device of the first embodiment of the present invention seen from the back side;

FIG. 3 is a perspective view illustrating a state in which a front cover, a back cover, and an upper cover are detached from the oxygen concentrating device of the first embodiment of the present invention and seen from the front side;

FIG. 4 is a perspective view illustrating a state in which the front cover, the back cover, and the upper cover are detached from the oxygen concentrating device of the first embodiment of the present invention and seen from the back side;

FIG. 5 is a perspective view illustrating a state of a support used in the oxygen concentrating device of the first embodiment of the present invention seen from the front side;

FIG. 6 is a perspective view illustrating a state of the support used in the oxygen concentrating device of the first embodiment of the present invention seen from the back side;

FIG. 7 is a view illustrating a flowchart of the oxygen concentrating device of the first embodiment of the present invention;

FIG. 8 is a perspective view illustrating a state of the front cover 23 used in the oxygen concentrating device of the first embodiment of the present invention seen from the front side;

FIG. 9 is a perspective view illustrating a state of a filter cover for air take-in port used in the oxygen concentrating device of the first embodiment of the present invention seen from the front side;

FIG. 10 is a perspective view illustrating a state of a filter holder used in the oxygen concentrating device of the first embodiment of the present invention seen from the side;

FIG. 11 is a view illustrating a system flow of an oxygen concentrating device of a second embodiment of the present invention;

FIG. 12 is a perspective view illustrating an exploded state of an oxygen concentrating device of a first example according to the second embodiment;

FIG. 13 is a cross-sectional view illustrating a compressor box wrapped with cushion material of the oxygen concentrating device of the first example according to the second embodiment;

FIG. 14 is a cross-sectional view illustrating a solenoid valve wrapped with cushion material of the oxygen concentrating device of the first example in the second embodiment:

FIG. 15 is a perspective view illustrating a support of the oxygen concentrating device of the first example in the second embodiment;

FIG. 16 is a view illustrating the support of the oxygen concentrating device of the first example in the second embodiment seen from the back side;

FIG. 17 is a perspective view illustrating an outer appearance of the oxygen concentrating device of the first example in the second embodiment;

FIG. 18 is a cross-sectional view illustrating a the oxygen concentrating device of the first example in the second embodiment cut along a plane perpendicular to a left and right direction;

FIG. 19 is a perspective view illustrating a state in which the support in the oxygen concentrating device of a second example in the second embodiment is exploded to a main body and a lid;

FIG. 20 is a view illustrating the main body of the support in the oxygen concentrating device of the second example in the second embodiment seen from the back side;

FIG. 21 is a perspective view illustrating an exploded state of the oxygen concentrating device of the second example in the second embodiment;

FIG. 22 is a perspective view illustrating an outer appearance of the oxygen concentrating device of the second example in the second embodiment;

FIG. 23 is a perspective view illustrating an exploded state of the oxygen concentrating device of a third example in the second embodiment;

FIG. 24 is a view illustrating the support in the oxygen concentrating device of the third example in the second embodiment seen from the back side; and

FIG. 25 is a perspective view illustrating an outer appearance of the oxygen concentrating device of the third example in the second embodiment,

### DESCRIPTION OF SYMBOLS

101 oxygen concentrating device
102 adsorbing column
103 storing tank
104 gas transferring means
105 gas transferring means accommodation box
106 solenoid valve
108 control means
109 support
110 cover
111 air take-in port filter
112 concentrated oxygen gas take-out port
113 exhaust gas discharge port (silencer)
114 bottom plate (support)
115 side plate (support)
116 side plate (support)
117 partition plate (support)
119 adsorbing column holder insertion part
120 adsorbing column holder
121 caster
122 reinforcement member
123 front cover (cover)
124 back cover (covet)
125 right cover (cover)
126 left cover (cover)
127 upper cover (cover)
128 air take-in port
129 filter cover
130 pass-through hole
131 intake filter
132 filter holder
134 sound deadening tank
135 sound deadening tank
136 pressure detection means
137 pressure equalizing valve
138 orifice
139 orifice
140 check valve
141 check valve
142 bacteria filter
143 flow rate control means
144 oxygen concentration detection means
145 pressure detection means
146 flow rate detection means
147 check valve
148 humidifier means
149 sound deadening tank
201 intake filter
202 sound deadening tank arranged on gas flow path on material air introducing side of gas transferring means
203 compressor (gas transferring means)
204 solenoid valve block
204a solenoid valve (material air supply valve for adsorbing column 206)
204b solenoid valve (exhaust gas discharge valve for adsorbing column 206)
205a solenoid valve (material air supply valve for adsorbing column 207)
205b solenoid valve (exhaust gas discharge valve for adsorbing column 207)
206 adsorbing column
207 adsorbing column
208 pressure equalizing valve (for upper pressure equalization)
209 orifice (for upper pressure equalization)
210a check valve
210b check valve
211 storing tank
212 pressure detection means (for material air introducing path)
213 sound deadening tank arranged on gas flow path on exhaust gas exporting side of adsorbing tank
214 silencer
215 bacteria filter
216 proportional control valve
217 oxygen concentration detection means
218 pressure detection means (for concentrated oxygen gas take-out flow path)
219 check valve (for concentrated oxygen gas take-out flow path)
220 humidifier means
221 concentrated oxygen gas take-out port
222 support main body (support)
222a gas transferring means accommodation chamber
222b intake filter accommodation chamber
222c cooling fan accommodation chamber
222d adsorbing column accommodation chamber (for adsorbing column 206)
222e adsorbing column accommodation chamber (for adsorbing column 207)
222f storing tank accommodation chamber
222g control means accommodation chamber
222h solenoid valve accommodation chamber
223 support outer frame (support)
224 operation unit
225 support lid (support)
226 front cover (cover)
227 back cover (cover)
228 compressor box (metal gas transferring means accommodation box)
229 cooling fan
230 control means
231 sound absorbing material
232 cushion material
233 rivet
234 sound deadening tank arranged on gas flow path on material air exporting side of gas transferring means
235 flow rate detection means
236 orifice (for purge)

### BEST MODE FOR CARRYING OUT THE INVENTION

Preferred embodiments of an oxygen concentrating device of the present invention will be specifically described below using the drawings.

1.0 Oxygen Concentrating Device of First Embodiment

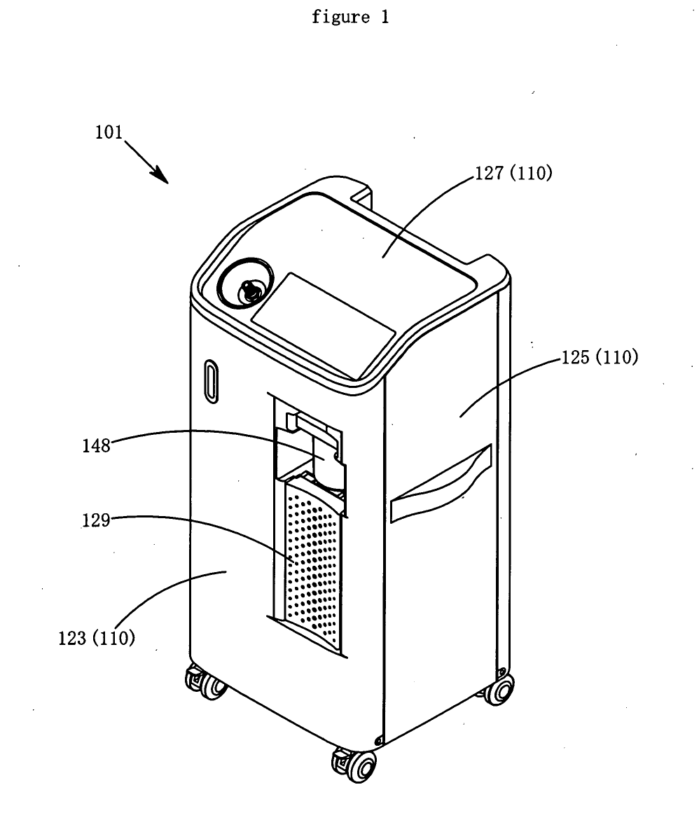

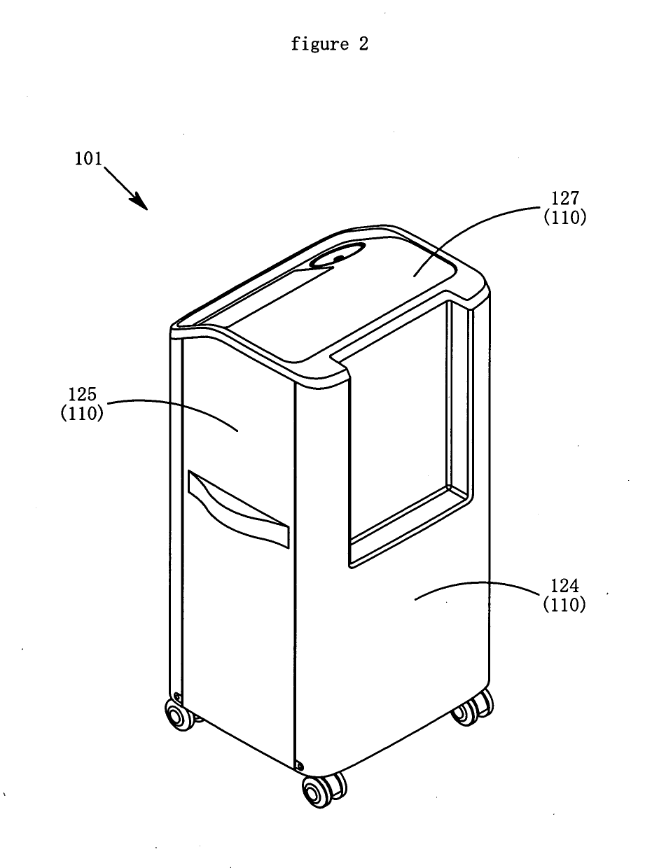

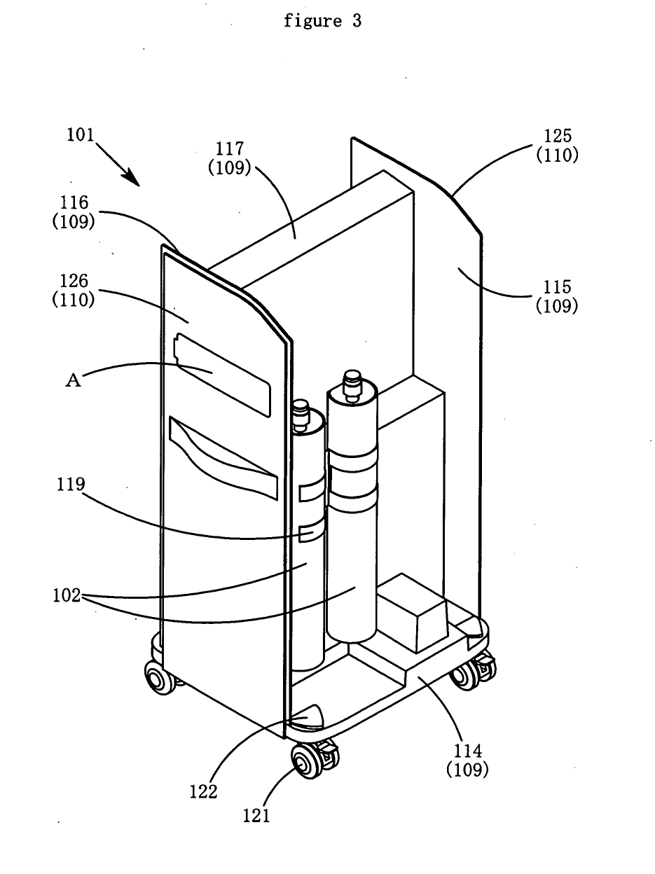

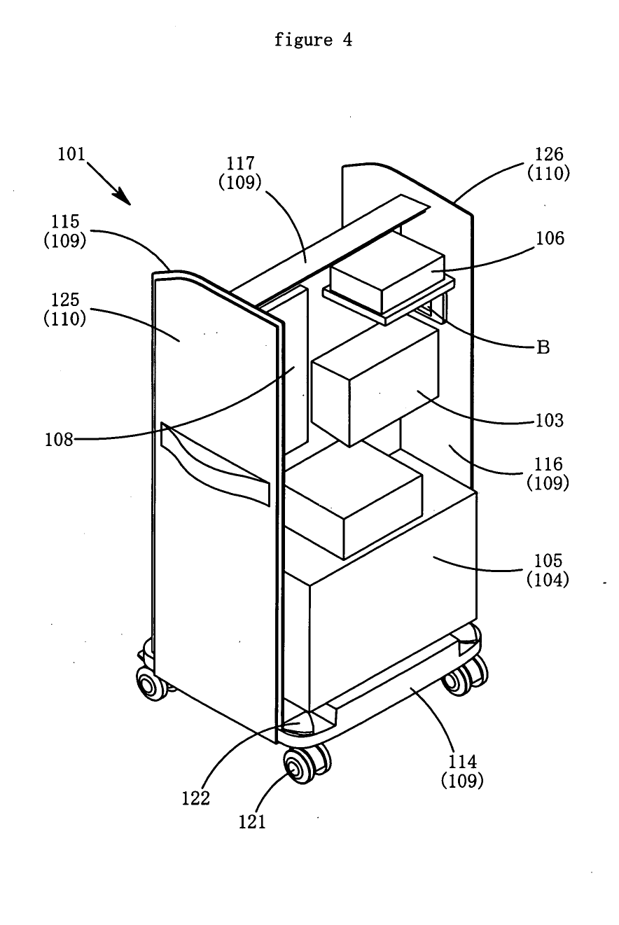

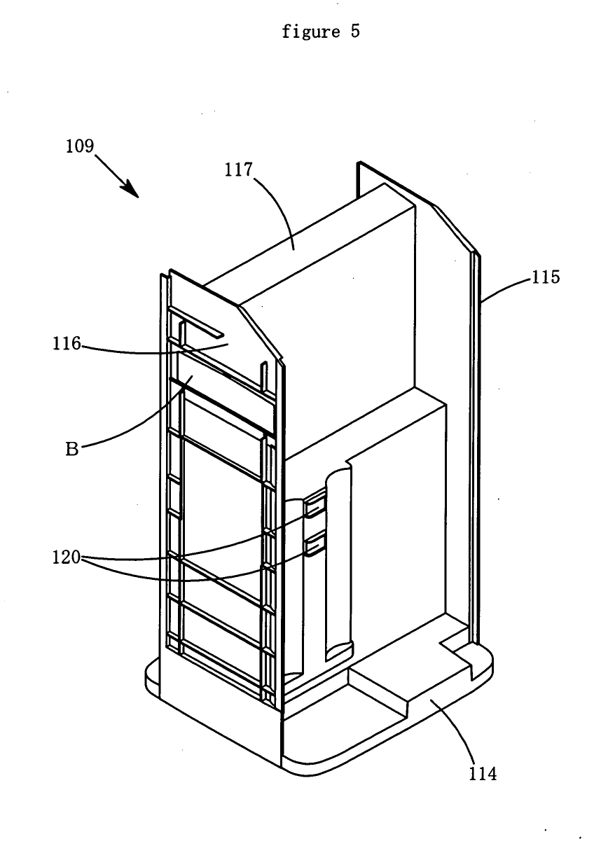

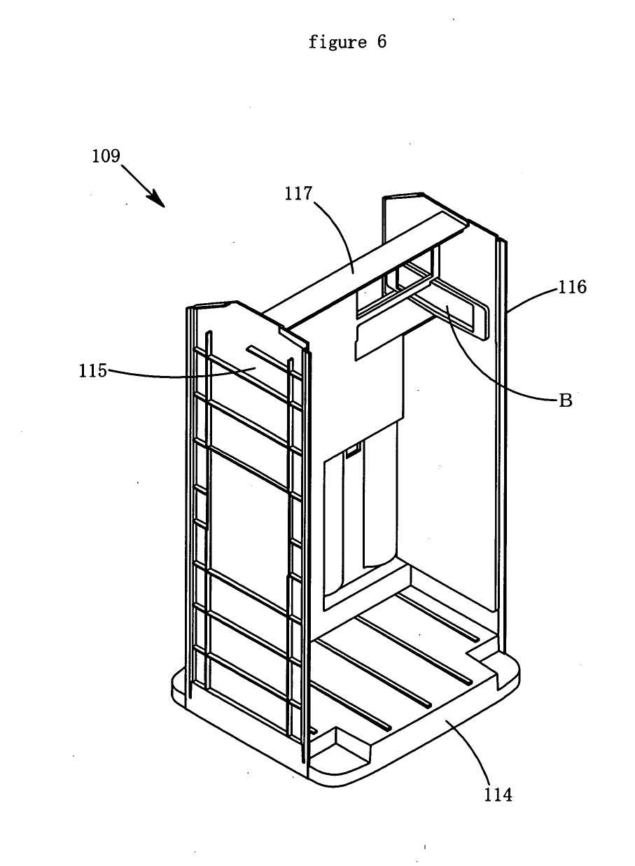

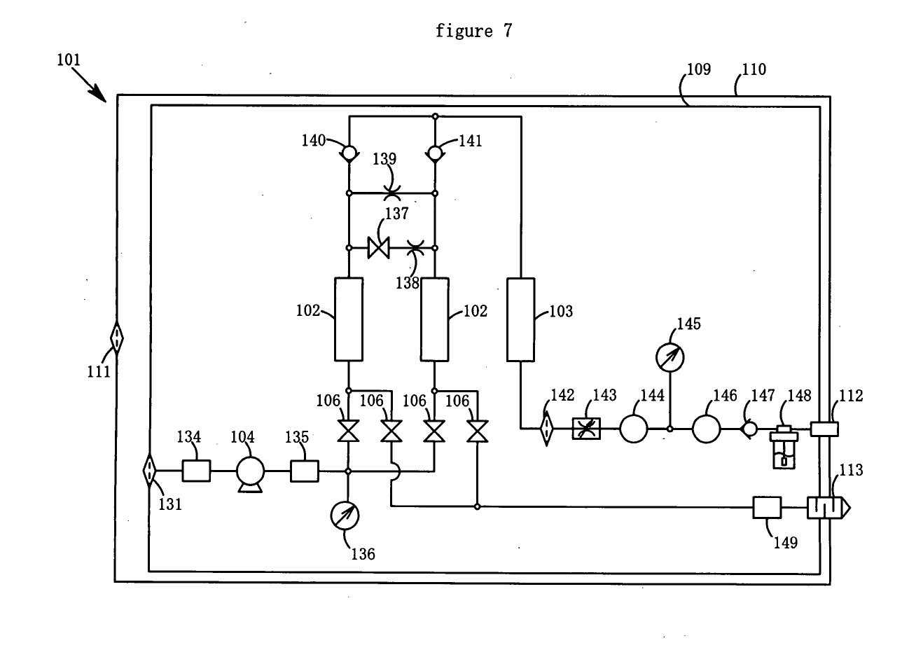

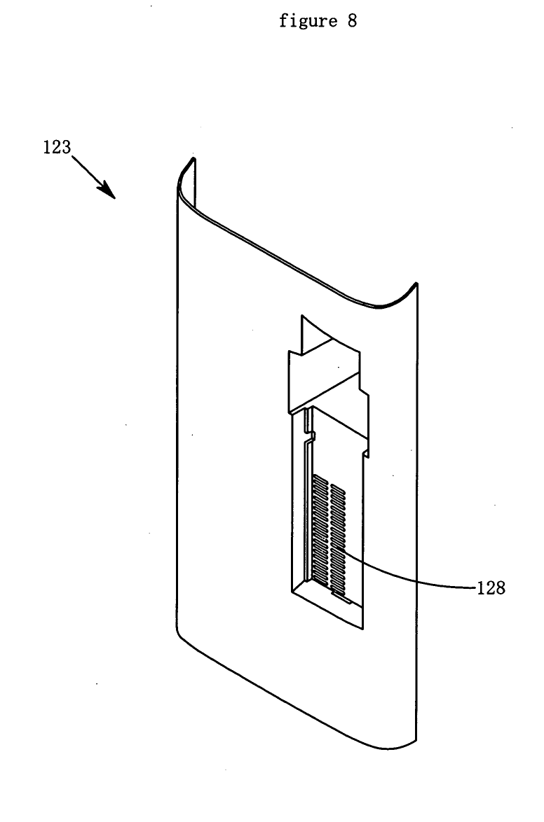

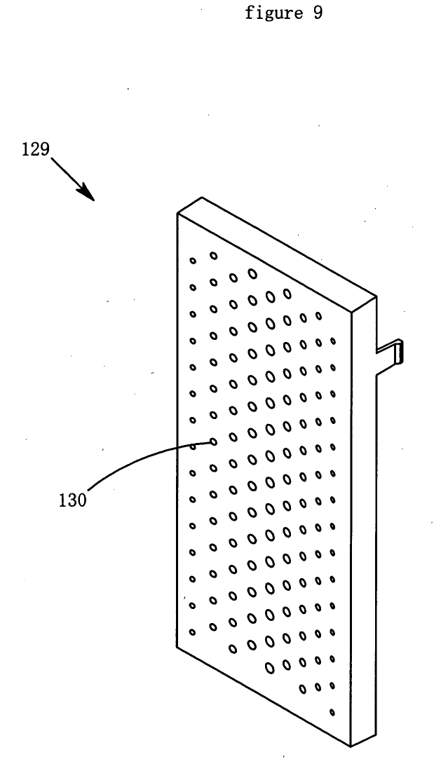

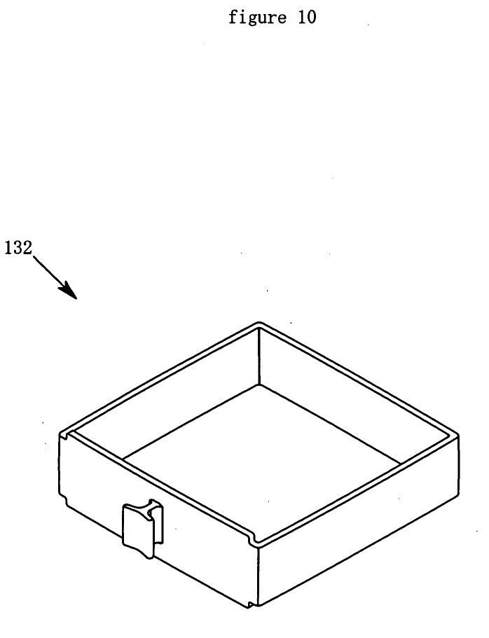

First, the oxygen concentrating device of the first embodiment will be described. FIG. 1 is a perspective view illustrating a state of an oxygen concentrating device 101 of the first embodiment of the present invention seen from the front side. FIG. 2 is a perspective view illustrating a state of the oxygen concentrating device 101 of the first embodiment of the present invention seen from the back side. FIG. 3 is a perspective view illustrating a state in which a front cover 123, a back cover 124, and an upper cover 127 are detached from the oxygen concentrating device 101 of the first embodiment of the present invention and seen from the front side. FIG. 4 is a perspective view illustrating a state in which the front cover 123, the back cover 124, and the upper cover 127 are detached from the oxygen concentrating device 101 of the first embodiment of the present invention and seen from the back side. FIG. 5 is a perspective view illustrating a state of a support 109 used in the oxygen concentrating device 101 of the first embodiment of the present invention seen from the front side. FIG. 6 is a perspective view illustrating a state of the support 109 used in the oxygen concentrating device 101 of the first embodiment of the present invention seen from the back side. FIG. 7 is a view illustrating a flowchart of the oxygen concentrating device 101 of the first embodiment of the present invention. FIG. 8 is a perspective view illustrating a state of the front cover 123 used in the oxygen concentrating device 101 of the first embodiment of the present invention seen from the front side. FIG. 9 is a perspective view illustrating a state of a filter cover 129 for air take-in port used in the oxygen concentrating device 101 of the first embodiment of the present invention seen from the front side. FIG. 10 is a perspective view illustrating a state of a filter holder 132 used in the oxygen concentrating device 101 of the first embodiment of the present invention seen from the lateral side. FIG. 3 and FIG. 4 are drawn with wirings and conduits omitted.

1.1 Brief Overview of Oxygen Concentrating Device of First Embodiment.

As illustrated in FIG. 1 to FIG. 4, the oxygen concentrating device 101 of the first embodiment is configured by a plurality of components including an adsorbing column 102 (FIG. 3) storing an adsorbent capable of selectively adsorbing nitrogen contained in the material air; a storing tank 103 (FIG. 4) for temporarily storing concentrated oxygen gas generated in the adsorbing column 102; a gas transferring means accommodation box 105 (FIG. 4) for accommodating a gas transferring means 104 for transferring the material air; an solenoid valve 106 (FIG. 4) for opening/closing a gas flow path connected to the adsorbing column 102; and a control means 108 for controlling the gas transferring means 104 and the solenoid valve 106. Such plurality of components are positioned and supported at predetermined locations by the support 109 illustrated in FIG. 5 and FIG. 6, and the support 109 is covered by a plurality of covers 110 made of resin (FIG. 1, FIG. 2).

The oxygen concentrating device 101 of the first embodiment adopts a pressure fluctuation adsorbing type of generating the concentrated oxygen gas by fluctuating the pressure of the adsorbing column 102 storing the adsorbent capable of selectively adsorbing nitrogen contained in the circumambient air (material air). As illustrated in FIG. 7, the material air taken in from an air take-in port filter 111 is pressure fed to the adsorbing column 102 in the oxygen concentrating device 101. When the material air is pressure fed to a primary side of the adsorbing column 102 (lower side of the adsorbing column 102 in the oxygen concentrating device of the first embodiment) and the internal pressure of the adsorbing column 102 rises, the nitrogen in the material air is adsorbed by the adsorbent, and the concentrated oxygen gas with increased oxygen concentration is taken out from a secondary side of the adsorbing column 102 (upper side of the adsorbing column 102 in the oxygen concentrating device of the first embodiment) (adsorbing process). The concentrated oxygen gas taken out is temporarily stored in the storing tank 103, and then taken out from a concentrated oxygen gas take-out port 112, as necessary.

The gas remaining in the adsorbing column 102 after the adsorbing process is terminated is discharged from an exhaust gas discharge port 113 (silencer) as exhaust gas. In this case, the pressure of the adsorbing column 102 lowers, the nitrogen adsorbed to the adsorbent desorbs from the adsorbent, and the nitrogen adsorbing ability of the adsorbent regenerates (regenerating process). The nitrogen desorbed from the adsorbent is discharged as exhaust gas. Thus, the exhaust gas discharged from the exhaust gas discharge port 113 becomes a nitrogen enriched gas with increased nitrogen concentration. The specific operation of each component configuring the oxygen concentrating device 101 is substantially similar to the general oxygen concentrating device of the pressure fluctuation adsorbing type, and thus the description thereof will be omitted.

1.2 Support

The support 109 is formed by injection molding of resin. The type of the resin used for the support 109 is not particularly limited as long as it can be injection molded. The ABS resin excelling in strength is used in the oxygen concentrating device 101 of the first embodiment.

The thickness of the support 109 (thickness of each plate-shaped part configuring the support 109) is not particularly limited. However, if the support 109 is too thin, the rigidity of the support 109 cannot be maintained and the support 109 may easily break. Thus, the thickness of the support 109 (average thickness if the thickness of the support 109 differs depending on the location) is preferably set to greater than or equal to 0.5 mm. The thickness of the support 109 is more preferably greater than or equal to 1 mm, and most preferably greater than or equal to 2 mm.

If the support 109 is too thick, not only does the weight of the support 109 increase, but the production cost of the oxygen concentrating device 101 also increases. Thus, the thickness of the support 109 is preferably set to smaller than or equal to 5 mm. The thickness of the support 109 is more preferably smaller than or equal to 4 mm, and most preferably smaller than or equal to 3 mm. In the oxygen concentrating device 101 of the first embodiment, the support 109 is 0.8 mm at the thinnest location and 4 mm at the thickest location, and about 2.5 mm on average.

The mode of the support 109 is not particularly limited as long as it can position and support the plurality of components at predetermined locations. In the oxygen concentrating device 101 of the first embodiment, the support 109 is integrally formed by a bottom plate 114, a pair of side plates 115, 116 upstanding perpendicularly from both side edges of the bottom plate 114, and a partition plate 117 for partitioning a space sandwiched by the pair of side plates 115, 116 to the front and the back, as illustrated in FIG. 5 and FIG. 6. Thus, the support 109 can not only easily assemble the plurality of components, but can also provide excellent strength to the oxygen concentrating device 101.

In the oxygen concentrating device 101 of the first embodiment, a plurality of reinforcement ribs is arranged at the bottom plate 114, the side plates 115, 116, and the like of the support 109, as illustrated in FIG. 5, thereby enhancing the rigidity of the support 109. The arrangement of the reinforcement ribs is not particularly limited, but the rigidity of the support 109 can be further enhanced if arranged in a lattice form. The dimension of the reinforcement rib is also not particularly limited, but the height of the reinforcement rib is normally set in a range of between 5 and 50 mm, and the spacing of the adjacent reinforcement ribs is set in a range of between 50 and 200 mm.

A ventilation path (not illustrated) surrounded by the reinforcement ribs is formed at a bottom surface of the bottom plate 114, which ventilation path may function as an exhaust duct. The exhaust duct is formed so as to guide the exhaust gas from the front side to the back side of the oxygen concentrating device 101. Thus, a long distance from a noise generating source to the portion where the exhaust gas is discharged to the outer side of the cover 110 is ensured, and the noise of the oxygen concentrating device 101 can be further reduced.

The partition plate 117 is formed with concave-convex parts to support the plurality of components such as the adsorbing column 102, the storing tank 103, the gas transferring means accommodation box 105, the solenoid valve 106, and the control means 108 each at the desired position. The concave-convex parts not only position the plurality of components, but also have an effect of providing rigidity to the partition plate 117 and enhancing the strength of the support 109.

As illustrated in FIG. 5, an adsorbing column holder insertion part 120 is arranged in the vicinity of the portion for supporting the adsorbing column 102 in the partition plate 117. As illustrated in FIG. 3, the adsorbing column holder insertion part 120 can be inserted with an adsorbing column holder 119 having an arm for pressing down the peripheral part of the adsorbing column 102. Thus, the adsorbing column 102 can be supported by the support 109 without using screws and the like.

When supporting the plurality of components at the support 109, the components are preferably supported by the support 109 by way of a cushion material. The components are then protected from impact, and furthermore, the vibration of the components can be absorbed and the noise generated from the oxygen concentrating device 101 can be reduced. Moreover, the assembly of the components to the support 109 can be easily carried out. The component using the cushion material is not particularly limited, but the cushion material is preferably used for at least one of the gas transferring means accommodation box 105 which accommodates the gas transferring means and the solenoid valve 106, and the cushion material is more preferably used for both since the gas transferring means 104 and the solenoid valve 106 tend to generate strong vibration and the generating noise is also large.

The arrangement of the plurality of components (which component to support at which portion of the support 109) is not particularly limited, but the components that generate a relatively large noise such as the gas transferring means 104 and the solenoid valve 106 are preferably arranged on the back side than the partition plate 117. The noise emitted towards the front from the oxygen concentrating device 101 is thereby reduced. In the oxygen concentrating device 101 of the first embodiment, the gas transferring means accommodation box 105, which accommodates the gas transferring means 104, and the solenoid valve 106 are arranged on the back side than the partition plate 117.

As illustrated in FIG. 3, casters 121 are attached to the bottom surface of the bottom plate 114, so that the oxygen concentrating device 101 can be easily transported. A reinforcement member 122 is attached to four corners of the bottom plate 114 to be attached with the casters 121, so that the bottom plate 114 does not break by the stress applied from the casters 121. The material of the reinforcement member 122 is not particularly limited, but that having a higher strength than the material used for the bottom plate 114 (support 109) is normally selected. In the oxygen concentrating device 101 of the first embodiment, a plate material made of polyacetal is used for the reinforcement member 122.

1.3 Cover

The material of the cover 110 is not particularly limited as long as it is resin, and polypropylene is used in the oxygen concentrating device 101 of the first embodiment. Thus, the production cost of the oxygen concentrating device 101 can be suppressed, and furthermore, it is easy to have the cover 110 to less likely to change color.

The thickness of the cover 110 is not particularly limited. However, if the cover 110 is too thin, the rigidity of the cover 110 cannot be maintained and the cover 110 may easily dent or break. Thus, the thickness of the cover 110 (average thickness when the thickness of the cover 110 differs depending on the location) is preferably set to greater than or equal to 0.5 mm. The thickness of the cover 110 is more preferably greater than or equal to 1 mm, and most preferably greater than or equal to 2 mm.

If the cover 110 is too thick, not only does the weight of the cover 110 increase, but the production cost of the oxygen concentrating device 101 also increases. Thus, the thickness of the cover 110 is preferably set to smaller than or equal to 5 mm. The thickness of the cover 110 is more preferably smaller than or equal to 4 mm, and most preferably smaller than or equal to 3 mm. In the oxygen concentrating device 101 of the first embodiment, the cover 110 is 0.8 mm at the thinnest location and 4 mm at the thickest location, and about 2.5 mm on average. A reinforcement rib similar to that arranged on the support 109 is arranged on the back surface of the cover 110 to enhance the strength of the cover 110.

The number of cover 110 is not particularly limited as long as it is greater than or equal to two. As illustrated n FIG. 1 to FIG. 4, a total of five is arranged in the oxygen concentrating device 101 of the first embodiment, or the front cover 123 for covering the front side of the support 109, the back cover 124 for covering the back side of the support 109, the right cover 125 for covering the right side facing the front of the support 109, the left cover 126 for covering the left side facing the front of the support 109, and the upper cover 127 for covering the upper part of the support 109. Thus, when the cover 110 is damaged by any possibility, only the damaged one needs to be replaced with a new one, and thus the repair task can be alleviated. The cover 110 and the support 109 are respectively arranged with a fit-in part, so that the cover 110 and the support 109 can be fitted and fixed to each other with the fit-in part. The upper cover 127 can be attached with an operation unit (not illustrated) for operating the oxygen concentrating device 101 and a display unit (not illustrated) for displaying status and warning notice of the oxygen concentrating device 101.

As illustrated in FIG. 8, the front cover 123 is formed with an air take-in port 128 for taking in air to the inner side of the cover 110. The air take-in port 128 can be attached with an air take-in port filter for removing dust coexisting in the air taken in, and a filter cover 129 (FIG. 1) for covering the outer side of the air take-in port filter. In the oxygen concentrating device 101 of the first embodiment, a concave part (filter cover attachment part) is arranged at the periphery of the air take-in port 128 in the front cover 123, and the filter cover 129 holding the air take-in port filter can be fitted to the concave part. The filter cover 129 can be detached from the concave part arranged at the periphery of the air take-in port 128, so that maintenance such as replacement of the air take-in port filter can be easily carried out.

As illustrated in FIG. 9, the filter cover 129 is formed with a plurality of pass-through holes 130 for taking in air. The outer surface of the air take-in port filter may be closely attached to the inner surface of the filter cover 129, but is preferably arranged with a predetermined spacing (about 1 to 20 mm) from the inner surface of the filter cover 129. The air taken in from the pass-through hole 130 then can be prevented from locally passing through the air take-in port filter. Therefore, the early clogging of the air take-in port filter and the like can be prevented.

The shape of the pass-through hole 130 formed in the filter cover 129 is not particularly limited and may be polygonal, elliptical, and the like, but is a circle in the oxygen concentrating device 101 of the first embodiment. The diameter of each pass-through hole 130 (diameter of an equivalent round (circle having an area same as a cross-sectional area of the pass-through hole 130) when the pass-through hole 130 is a non-circle) is also not particularly limited, but dust tends to easily clog the pass-through hole 130 if too small, and the dust attached to the air take-in port filter is easily seen from the outside and the outer appearance of the oxygen concentrating device 101 may degrade if too large. Thus, the diameter of each pass-through hole 130 is normally set to about 1 to 10 mm. In the oxygen concentrating device 101 of the first embodiment, the diameter of the pass-through hole 130 becomes larger in a step-wise manner from 2.5 mm to 4 mm from both side ends towards the center of the filter cover 129, and a sophisticated impression in terms of outer appearance can be provided.

As illustrated in FIG. 8, the front cover 123 is formed with a humidifier means attachment part (depression in the oxygen concentrating device 101 of the first embodiment) for attaching a humidifier means 148 (FIG. 1, FIG. 7), and the humidifier means 148 can be easily attached to the front cover 123. Thus, not only the production cost of the oxygen concentrating device 101 reduces, but the maintenance of the humidifier means 148 can be easily carried out.

Furthermore, audio output means such as speaker and buzzer (not illustrated) may be arranged in the oxygen concentrating device 101 of the first embodiment. Voice guidance and alarm sound related to the oxygen concentrating device 101 then can be output. The place for arranging the audio output means is not particularly limited, but is preferable if directly attached to the cover 110 or the support 109 so that the audio of the audio output means can be easily propagated to the outside of the oxygen concentrating device 101, and the voice guidance and the alarm sound can be output more clearer.

The oxygen concentrating device 101 of the first embodiment is arranged with an intake filter 131 (FIG. 7) for further reliably removing dust coexisting in air (material air) taken into the inner side of the cover 110 through the air take-in port 128. The intake filter 131 can be inserted to the interior of the oxygen concentrating device 101 from an opening B formed at the side plate 116 (FIG. 5) while being held by a filter holder 132 (FIG. 10). A space is formed on the inner side of the opening B in the side plate 116, and the filter holder 132 is accommodated in the space. An opening A (FIG. 3) for inserting and removing the filter holder 132 is formed on the left cover 126 arranged on the outer side of the side plate 116. The opening A and the opening B are arranged at positions overlapping each other, and a lid is attached to the opening A. Thus, maintenance of the oxygen concentrating device 101 such as replacement and cleaning of the intake filter 131 can be easily carried out.

1.4 Application of Oxygen Concentrating Device of the First Embodiment

The oxygen concentrating device of the first embodiment of the present invention can be used for various applications. Among them, it can be suitably used as a medical oxygen concentrating device used when carrying out oxygen inhalation therapy, and a health oxygen concentrating device used to resolve lack of oxygen after exercise. In particular, it can be suitably used as a home care oxygen concentrating device (medical oxygen concentrating device used to carry out oxygen inhalation therapy at home) in which mass production at low cost and reduction of noise are being desired. Since the oxygen concentrating device of the first embodiment of the present invention can easily enhance impact resistance, demand for portable oxygen concentrating device is greatly expected. Furthermore, the oxygen concentrating device of the first embodiment of the present invention is not limited to targeting only humans, and may also target on animals.

2.0 Oxygen Concentrating Device of Second Embodiment

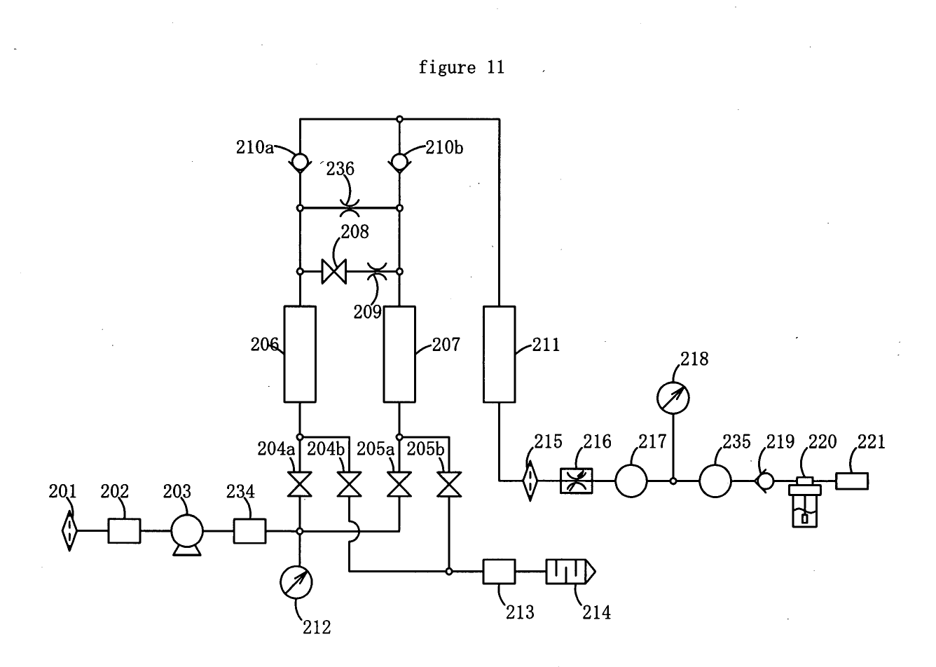

The oxygen concentrating device of the second embodiment will now be described. FIG. 11 is a view illustrating a system flow of the oxygen concentrating device of the second embodiment of the present invention. The oxygen concentrating device illustrated in FIG. 11 includes a plurality of components such as adsorbing columns 206, 207 storing an adsorbent capable of selectively adsorbing nitrogen contained in the material air; a storing tank 211 for temporarily storing the concentrated oxygen gas generated in the adsorbing columns 206, 207; a gas transferring means 203 for transferring the material air, the concentrated oxygen gas or exhaust gas; solenoid valves 204a, 240b, 205a, 205b for opening/closing a gas flow path connected to the adsorbing columns 206, 207; and a control means (not illustrated in FIG. 11) for controlling each part. In the oxygen concentrating device illustrated in FIG. 11, a compressor capable of pressure feeding the material air to the adsorbing columns 206, 207 is used as the gas transferring means 203.

As illustrated in FIG. 11, the oxygen concentrating device includes, in addition to the adsorbing columns 206, 207, the storing tank 211, the gas transferring means 203, the solenoid valves 204a, 204b, 205a, 205b, and the control means (not illustrated in FIG. 11), an intake filter 201 for removing dust and the like from the material air taken in; a sound deadening tank 202 for preventing pulsation sound of the material air generated in the gas transferring means 203 from leaking to the outside of the oxygen concentrating device through the intake filter 201; a sound deadening tank 234 for alleviating the pulsation sound of the material air exported from the compressor 203; a pressure detection means 212 for detecting the pressure of the material air supplied to the adsorbing columns 206, 207; a pressure equalizing valve 208 for performing upper pressure equalization of the adsorbing columns 206, 207; an orifice 209 connected in series with the pressure equalizing valve 208; an orifice 236 connected in parallel with the pressure equalizing valve 208; check valves 210a, 210b for preventing the backflow of the concentrated oxygen gas from the storing tank 211 to the adsorbing columns 206, 207; a sound deadening tank 213 and a silencer 214 for alleviating the noise generated when discharging the exhaust gas; a bacteria filter 215 for removing bacteria from the concentrated oxygen gas taken out from the storing tank 211; a proportional control valve 216 for adjusting the flow rate of the concentrated oxygen gas taken out from the storing tank 211; an oxygen concentration detection means 217 for detecting the oxygen concentration of the concentrated oxygen gas taken out from the storing tank 211; a pressure detection means 218 for detecting the pressure of the concentrated oxygen gas taken out from the storing tank 211; a flow rate detection means 235 for detecting the flow rate of the concentrated oxygen gas taken out from the storing tank 211; a check valve 219 for preventing the concentrated oxygen gas taken out from the storing tank 211 from back flowing to the storing tank 211; a humidifier means 220 for humidifying the concentrated oxygen gas taken out from the storing tank 211; a concentrated oxygen gas take-out port 221 for taking out the concentrated oxygen gas to the outside of the oxygen concentrating device, and the like.

The oxygen concentrating device illustrated in FIG. 11 is a pressure fluctuation adsorbing type that generates the concentrated oxygen gas while alternately switching between an adsorbing process of adsorbing the nitrogen contained in the material air to the adsorbent by pressure feeding the material air taken in from the intake filter 201 to the adsorbing columns 206, 207 with the compressor 203 and raising the pressure of the adsorbing columns 206, 207, and a regenerating process of desorbing the nitrogen adsorbed to the adsorbent by discharging the gas remaining in the adsorbing columns 206, 207 after the adsorbing process is terminated as the exhaust gas through the silencer 214, and lowering the pressure of the adsorbing columns 206, 207. The specific operation of each component configuring the oxygen concentrating device such as the solenoid valves 204a, 204b, 205a, 205b is substantially the same as the general oxygen concentrating device of the pressure fluctuation adsorbing type, and thus the description will be omitted.

Three suitable examples (first example, second example, third example) in the oxygen concentrating device of the second embodiment of the present invention will be described below, but the oxygen concentrating device of the present invention is not limited to such examples and the configuration thereof can be appropriately changed within a scope not deviating from the principle of the present invention.

2.1 Oxygen Concentrating Device of First Example in Second Embodiment

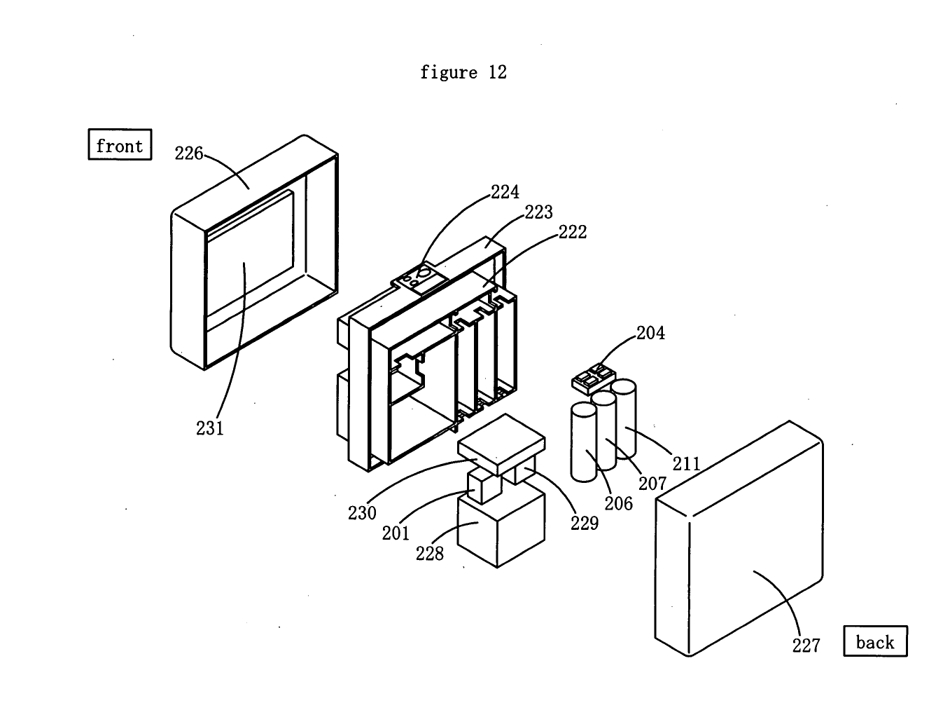

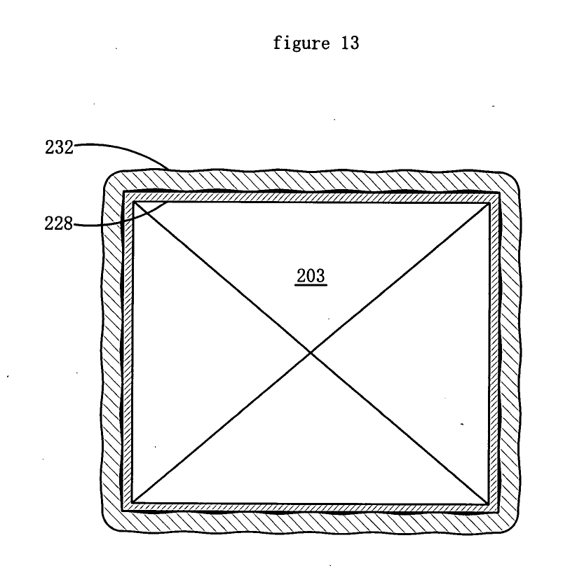

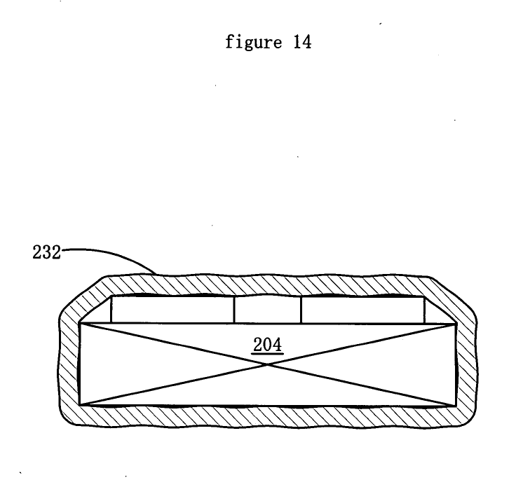

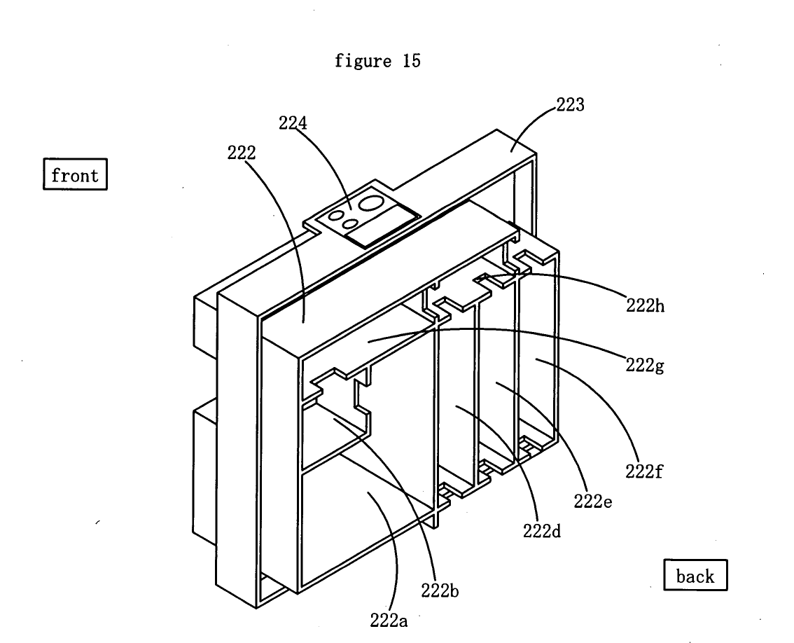

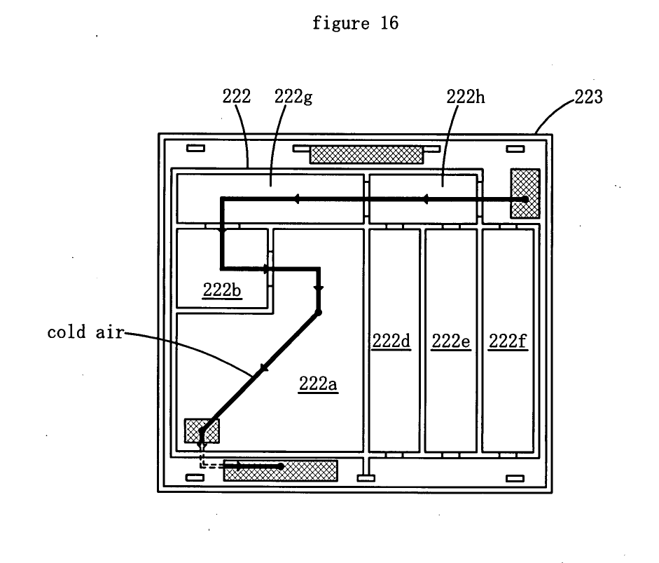

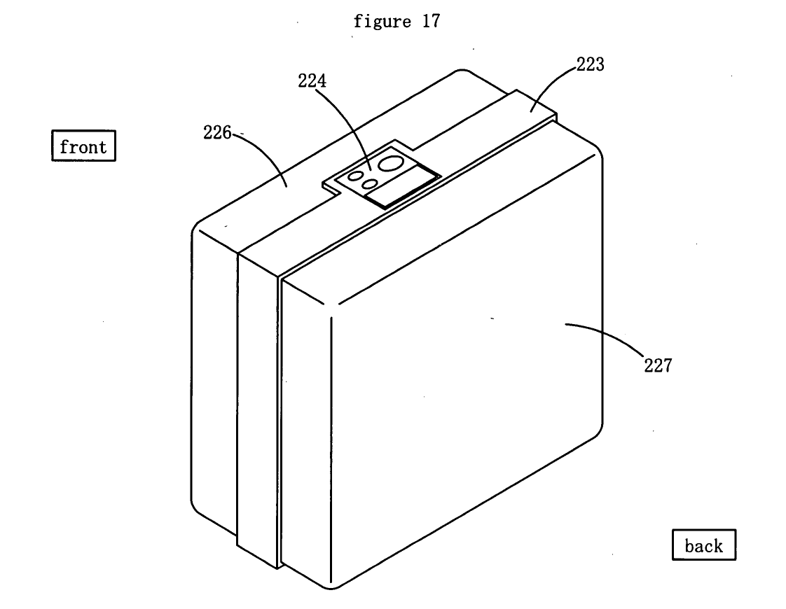

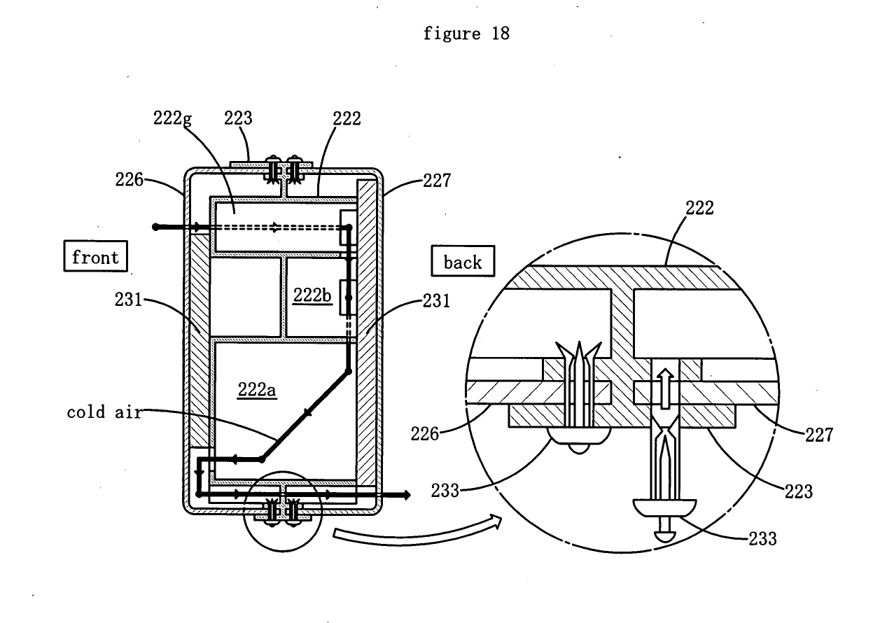

First, the oxygen concentrating device of a first example according to the second embodiment (hereinafter sometimes simply referred to as “oxygen concentrating device of the first example”) will be described. FIG. 12 is a perspective view illustrating an exploded state of the oxygen concentrating device of the first example. FIG. 13 is a cross-sectional view illustrating a compressor box wrapped with cushion material of the oxygen concentrating device of the first example. FIG. 14 is a cross-sectional view illustrating a solenoid valve wrapped with cushion material of the oxygen concentrating device of the first example. FIG. 15 is a perspective view illustrating a support of the oxygen concentrating device of the first example. FIG. 16 is a view illustrating the support of the oxygen concentrating device of the first example seen from the back side. FIG. 17 is a perspective view illustrating an outer appearance of the oxygen concentrating device of the first example. FIG. 18 is a cross-sectional view illustrating the oxygen concentrating device of the first example cut along a plane perpendicular to a left and right direction. In FIG. 16, an opening passing the support in the front and the back is illustrated with a shaded hatching.

As illustrated in FIG. 12, the oxygen concentrating device of the first example includes supports 222, 223 for supporting a plurality of components, and covers 226, 227 for covering the front and the back of the supports 222, 223.

As illustrated in FIG. 12, the supports 222, 223 are configured by a support main body 222 for positioning and supporting the plurality of components at predetermined locations, and a support outer frame 223 for fixing the support main body 222 to the covers 226, 227. The support main body 222 and the support outer frame 223 may be separately formed, but are integrally formed in the oxygen concentrating device of the first example. The support outer frame 223 is arranged with an operation unit 224 for operating the oxygen concentrating device. The support outer frame 223 may be arranged with a grip (not illustrated) so as to be gripped by hand. The oxygen concentrating device then can be easily carried around.

The material of the supports 222, 223 is not particularly limited, and may be wood, metal, or the like, but is preferably resin. The supports 222, 223 not only can be manufactured at low cost with satisfactory dimensional accuracy, but the weight of the supports 222, 223 can be lighter. The resin suitable for the material of the supports 222, 223 includes polyolefin such as polypropylene, polyethylene, and polybudene-1; styrene resin such as ABS (acrylonitrile-butadiene-styrene), MBS (methyl methacrylate-butadiene-styrene), and styrenetype resins such as polystyrene; acryl resin such as polymethyl methacrylate; polycarbonate; polyvinyl chloride; polyester such as polybutylene terephthalate and polyethylene terephthalate; polyamide and the like. The molding method of the supports 222, 223 is also not particularly limited, but injection molding, thermoforming of the sheet, blow molding, or the like is normally selected. Injection molding is suitable in terms of dimensional accuracy.

As illustrated in FIG. 12, the covers 226, 227 have a structure separable to the front cover 226 for covering the front side of the oxygen concentrating device and the back cover 227 for covering the back side of the oxygen concentrating device; where the support outer frame 223 is sandwiched between the front cover 226 and the back cover 227. The front cover 226 or the back cover 227 and the support outer frame 223 can be coupled and fixed using a rivet 233, as illustrated in FIG. 18. The oxygen concentrating device of the first example thus can be easily assembled and dissembled.

The material of the covers 226, 227 is not particularly limited, and may be wood, metal, or the like, but is preferably resin. By way of this, the covers 226, 227 not only can be manufactured at low cost with satisfactory dimensional accuracy, but the weight of the covers 226, 227 can be lighter. The resin suitable for the material of the covers 226, 227 includes those similar to the supports 222, 223. The molding method of the covers 226, 227 is also not particularly limited, but thermoforming of the sheet, blow molding, or the like is normally selected.

As illustrated in FIG. 18, a sound absorbing material 231 is arranged on the inner surface of the front cover 226 and the back cover 227. In the oxygen concentrating device of the first example, the sound absorbing material 231 is formed to a thick plate shape, so that the inner surface of the sound absorbing material 231 contacts the support main body 222 and each component supported by the support main body 222 when the front cover 226 and the back cover 227 are closed. Thus, not only is the rattling of the components supported by the support main body 222 suppressed, but the overall strength of the front cover 226 and the back cover 227 can be increased thereby preventing the deformation of the front cover 226 and the back cover 227.

The sound absorbing material 231 may be locally arranged only at the periphery of the component from which large noise is generated, but is arranged at all portions excluding the location where the opening for introducing cold air is arranged, the location necessary for flowing the cold air, and the like in the oxygen concentrating device of the first example, as illustrated in FIG. 18. Thus, the rattling of the components can be more effectively prevented. The sound absorbing material 231 can contribute to the prevention of deformation of the covers 226, 227.

The material of the sound absorbing material 231 is not particularly limited, and may use fiber assembly and the like, but resin foam is preferably used. The resin foam is not only easy to mold, but can effectively suppress the deformation of the covers 226, 227. The resin foam suitably used for the sound absorbing material 231 includes that obtained by foaming synthetic resin such as polyurethane and polyolefin. In the oxygen concentrating device of the first example, the resin foam formed to a thick plate shape by foaming polyurethane is used for the sound absorbing material 231. The air bubbles formed in the resin foam may be independent air bubbles, but communicating air bubbles can enhance the sound absorbency of the sound absorbing material 231.

The support main body 222 will be further described in detail. As illustrated in FIG. 18, the support main body 222 adopts a form of dividing the inner sides of the covers 226, 227 to the front and the back, and serves as a partition plate for partitioning the inner sides of the covers 226, 227 to the front and the back. Thus, the noise generated on the back side than the support main body 222 is less likely to reach the front surface side of the oxygen concentrating device.

In the oxygen concentrating device of the first example, the support main body 222 includes a gas transferring means accommodation chamber 222a, an intake filter accommodation chamber 222b, adsorbing column accommodation chambers 222d, 222e, a storing tank accommodation chamber 222f, a control means accommodation chamber 222g, and an solenoid valve accommodation chamber 222h on the back side, as illustrated in FIG. 15 and FIG. 16, where each accommodation chamber is partitioned by a plurality of partition walls.

As illustrated in FIG. 12, the gas transferring means accommodation chamber 222a accommodates a cooling fan 229 for transferring cold air, in addition to a metal gas transferring means accommodation box 228 (compressor box) accommodating the compressor 203 (not illustrated). The intake filter accommodation chamber 222b accommodates the intake filter 201, and the adsorbing column accommodation chamber 222d accommodates the adsorbing column 206. The adsorbing column accommodation chamber 222e accommodates the adsorbing column 207, and the storing tank accommodation chamber 222f accommodates the storing tank 211. The control means accommodation chamber 222g accommodates a control means 230, and the solenoid valve accommodation chamber 222h accommodates a solenoid valve block 204 in which the solenoid valves 204a, 204b, 205a and 205b (not illustrated) are grouped together.

Therefore, the noise emitted from the front side of the oxygen concentrating device can be reduced by arranging the compressor box 228 accommodating the compressor 203 (not illustrated) which tends to involve strong vibration and generate large noise, the solenoid valve block 204 in which the solenoid valves 204a, 204b, 205a and 205b (not illustrated) are grouped together, and the like on the back side of the support main body 222.

As illustrated in FIG. 13, the compressor box 228 is supported by the support main body 222 by way of a cushion material 232. Thus, not only is the compressor box 228 protected from impact, but the vibration of the compressor 203 that could not be removed with vibration absorption measure performed on the interior of the compressor box 228 can also be absorbed by the cushion material 232. Therefore, the noise of the oxygen concentrating device can be further reduced by the synergistic effect of the sound absorption measure performed on the interior of the compressor box 228, the sound absorbing material 231 arranged on the inner surfaces of the covers 226, 227, and the cushion material 232 covering the outer sides of the compressor box 228. The compressor box 228 can be reliably accommodated in the gas transferring means accommodation chamber 222a in the support main body 222 even if the dimensional tolerance of the compressor box 228 is large. In the oxygen concentrating device of the first example, the solenoid valve block 204 (see FIG. 14), the adsorbing columns 206, 207, and the storing tank 211 are also supported by the support main body 222 by way of the cushion material 232 in addition to the compressor box 228.

The material of the cushion material 232 is not particularly limited, but is preferably fiber assembly. The fiber assembly that can be suitably used for the cushion material 232 includes cloth (woven cloth, non-woven cloth, knitted fabric, and the like) of synthetic fiber, natural fiber, glass wool, and the like. Among them, the non-woven cloth is suitable, and the suitable thickness thereof is between 2 and 30 mm. The thickness of the non-woven cloth mentioned here is the thickness of when the load of 0.002 psi is applied, and a plurality of non-woven cloths can be superimposed to adjust to such thickness. The melt blown non-woven cloth is preferable from the standpoint of sound absorbing property, where the melt-blown non-woven cloth having a thickness of 13 mm (load of 0.002 psi) including polypropylene fiber and polyester fiber is used for the cushion material 232 in the oxygen concentrating device of the first example. The cushion material 232 excels not only in buffer property, but also in sound absorbing property and fire retardancy.

The cushion material 232 may be arranged only at the portion sandwiched by the component and the support main body 222, but substantially the entire surface of the components is covered with a sheet-form cushion material 232 in the oxygen concentrating device of the first example, as illustrated in FIG. 13 and FIG. 14. Thus, the noise of the oxygen concentrating device can be further reduced.

The partition wall for partitioning the solenoid valve accommodation chamber 222h and the control means accommodation chamber 222g, the control means accommodation chamber 222g and the intake filter accommodation chamber 222b, the intake filter accommodation chamber 222b and the gas transferring means accommodation chamber 222a is formed with a ventilation path, as illustrated in FIG. 15 and FIG. 16. Thus, the cooling fan 229 supported by the gas transferring means accommodation chamber 222a can supply cold air to the solenoid valve accommodation chamber 222h, the control means accommodation chamber 222g, and the gas transferring means accommodation chamber 222a (see thick arrow of FIG. 16). The cold air is introduced to the inner side of the covers 226, 227 from the front side of the oxygen concentrating device, and discharged to the outer side of the covers 226, 227 from the back side of the oxygen concentrating device, as illustrated in FIG. 18.

The arrangement of the solenoid valve accommodation chamber 222h, the control means accommodation chamber 222g, and the gas transferring means accommodation chamber 222a is not particularly limited, but the control means accommodation chamber 222a and the solenoid valve accommodation chamber 222h are arranged on an upstream side in the cold air flowing direction than the cooling fan 229, and the gas transferring means accommodation chamber 222a is arranged on a downstream side in the cold air flowing direction than the cooling fan 229 in the oxygen concentrating device of the first example. Thus, each component of the oxygen concentrating device can be efficiently cooled.

The ventilation path formed in the partition wall is not particularly limited as long as it is in a form of passing the cold air, and may be pass-through hole etc., but is arranged by forming a cutout at a back end edge of the respective partition wall, as illustrated in FIG. 15, in the oxygen concentrating device of the first example. The ventilation path may also be used as a conduit path for passing a rubber tube etc., a wiring path for passing electrical wire, and the like. The conduit path and the wiring path may be arranged separately from the ventilation path.

The sound deadening tanks 202, 213, and 234 may be made of resin and the like, but are preferably made of hard material such as metal. If the sound deadening tanks 202, 213, and 234 are made of deformable material such as resin, the sound deadening tanks 202, 213, and 234 themselves expand and contract, and may become the noise generation source. In the oxygen concentrating device of the first example, the sound deadening tanks 202, 213, and 234 are formed by extruding aluminum, and not only is it likely to become the noise generation source, but can be mass produced at low cost.

The form of the sound deadening tanks 202, 213, and 234 is not particularly limited as long as it is a tank shape having a sound deadening effect with a gas introduction port and a gas discharge port. By arranging an impediment wall that inhibits the flow of gas in the interior of the sound deadening tanks 202, 213, and 234, and making the path length connecting the gas introduction port and the gas discharge port of the sound deadening tanks 202, 213, and 234 set long, the sound deadening effect of the sound deadening tanks 202, 213, and 234 is further enhanced. The capacity of the sound deadening tanks 202, 213, and 234 is not particularly limited as well, but is normally set to between 0.1 and 1 liter. In the oxygen concentrating device of the first example, the capacity of the sound deadening tanks 202, 213, and 234 is 0.3 liter.

In the oxygen concentrating device of the first example, the sound deadening tanks 202, 213, and 234 are accommodated in the compressor box 228. Thus, not only can the noise of the oxygen concentrating device be further reduced, but the sound deadening tanks 202, 213, and 234 can be cooled by the cooling fan 229 along with the compressor 203.

The arrangement of the sound deadening tanks 202, 213 and 234 in the compressor box 228 is not particularly limited, but the sound deadening tank 213 is preferably arranged on the upper side than the sound deadening tank 234. Thus, the heat generated in the sound deadening tank 234 can be released to the outside of the oxygen concentrating device with the exhaust gas discharged through the sound deadening tank 213 by arranging the sound deadening tank 213 arranged on the gas flow path on the exhaust gas exporting side of the adsorbing columns 206, 207 on the upper side than the sound deadening tank 234 arranged on the gas flow path on the material gas exporting side of the compressor 203 and which temperature tends to easily rise. In the oxygen concentrating device of the first example, the sound deadening tank 213 is arranged immediately above the sound deadening tank 234, and the sound deadening tank 202 is arranged immediately above the sound deadening tank 213. The sound deadening tank 234 and the sound deadening tank 213 preferably contact in terms of heat transmission property, and are more preferably integrally formed with metal having satisfactory heat transmission property such as aluminum. All sound deadening tanks 202, 213, and 234 may be integrally formed.

2.2 Oxygen Concentrating Device of Second Example in Second Embodiment

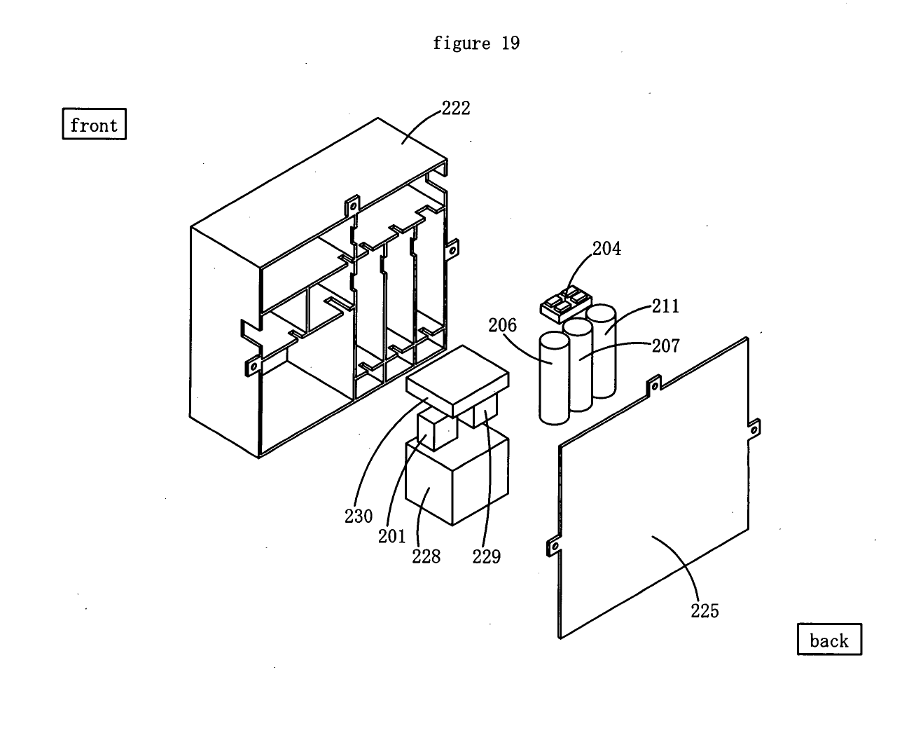

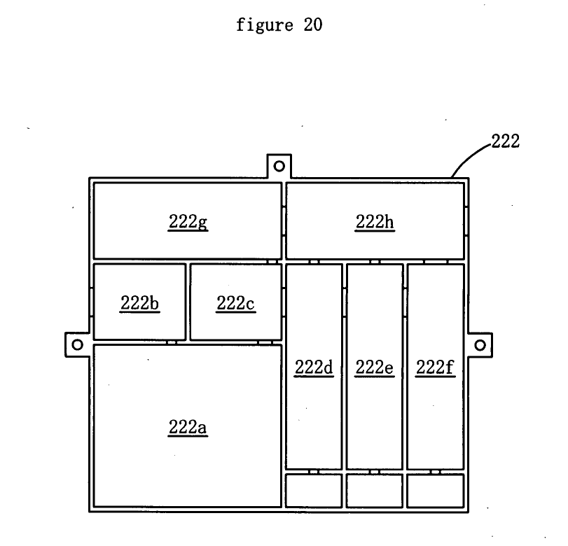

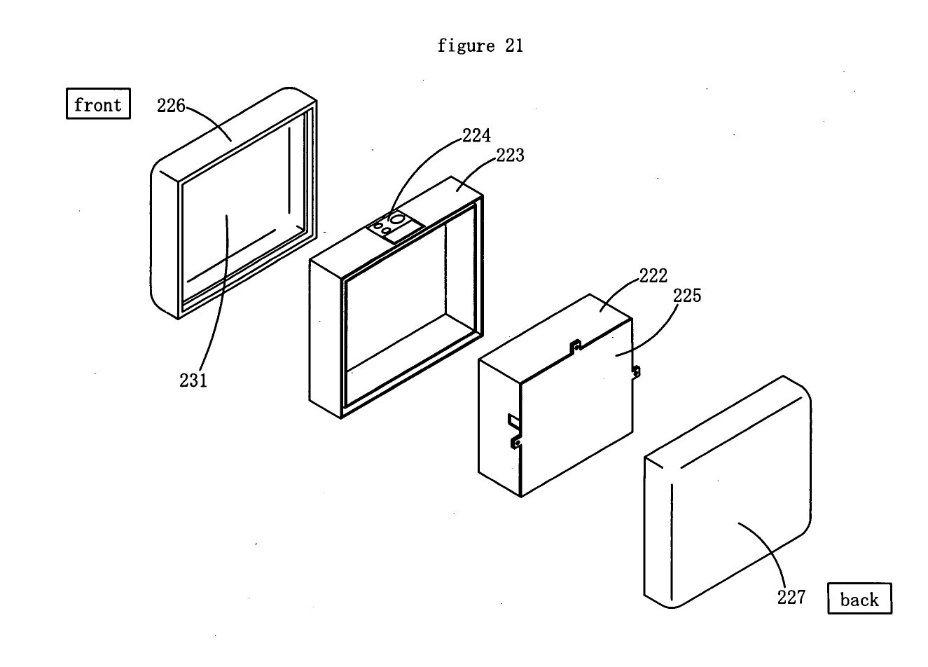

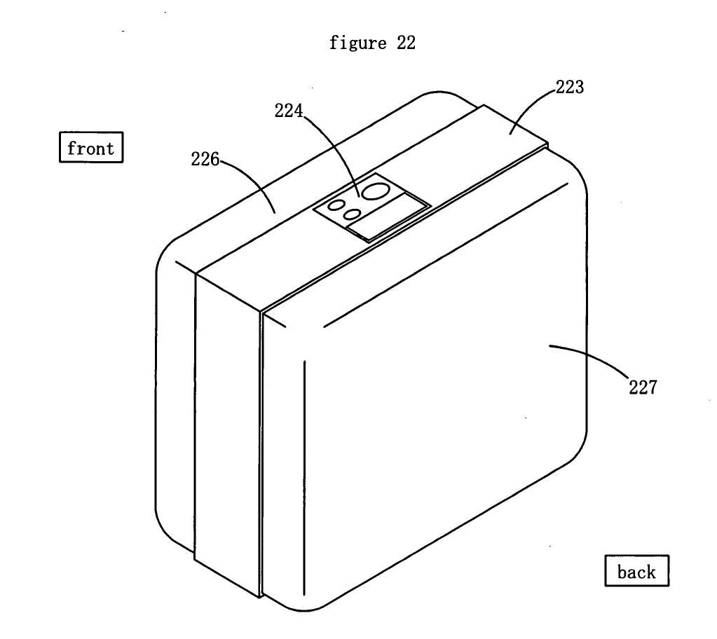

An oxygen concentrating device of a second example in the second embodiment (hereinafter sometimes simply referred to as “oxygen concentrating device of the second example”) will now be described. FIG. 19 is a perspective view illustrating a state in which the support in the oxygen concentrating device of the second example is exploded to a main body and a lid. FIG. 20 is a view illustrating the main body of the support in the oxygen concentrating device of the second example seen from the back side. FIG. 21 is a perspective view illustrating an exploded state of the oxygen concentrating device of the second example. FIG. 22 is a perspective view illustrating an outer appearance of the oxygen concentrating device of the second example.

As illustrated in FIG. 19 and FIG. 21, the oxygen concentrating device of the second example takes a mode in which the back side of the support main body 222 is covered with a support lid 225. As illustrated in FIG. 20, a partition wall is also arranged between a cooling fan accommodation chamber 222c for supporting the cooling fan 229 and the gas transferring means accommodation chamber 222a. Thus, not only can the plurality of components be reliably supported by the support main body 222, but the noise emitted from the oxygen concentrating device can be further reduced. Other configurations in the oxygen concentrating device of the second example are substantially the same as the oxygen concentrating device of the first example, and thus the description will be omitted.

2.3 Oxygen Concentrating Device of Third Example in Second Embodiment

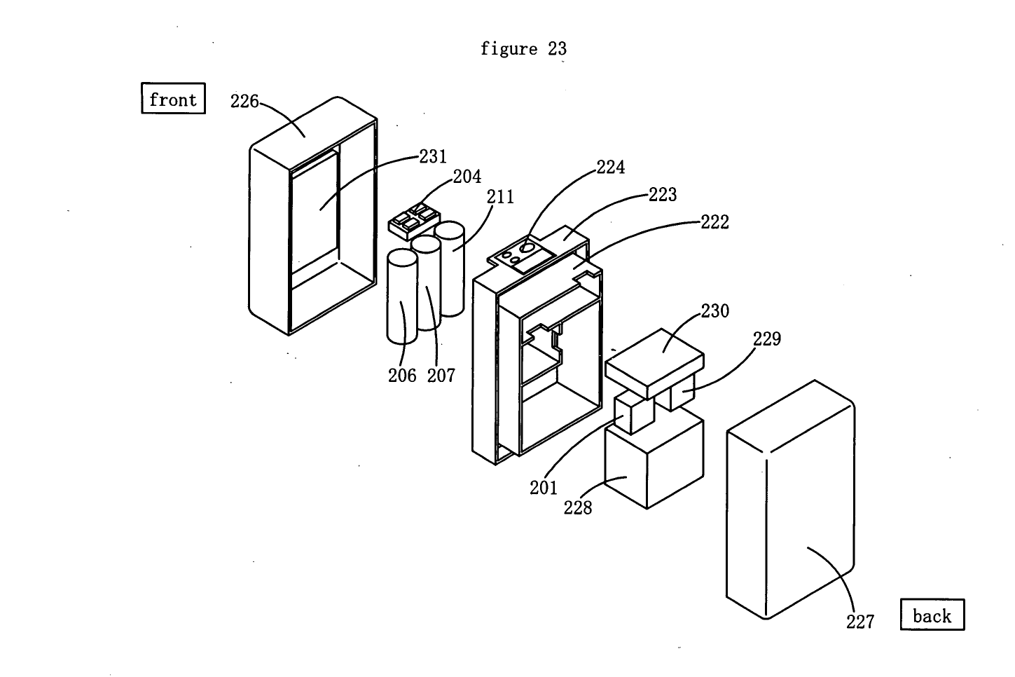

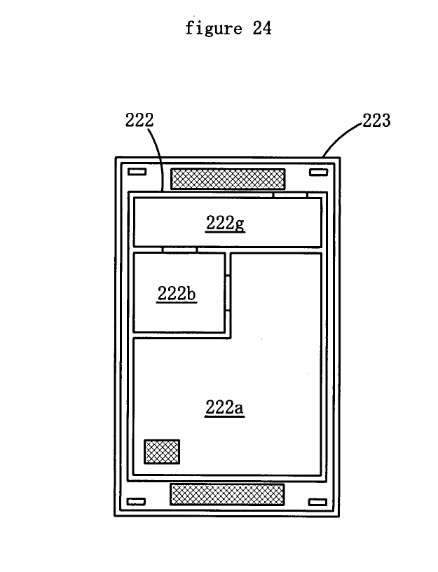

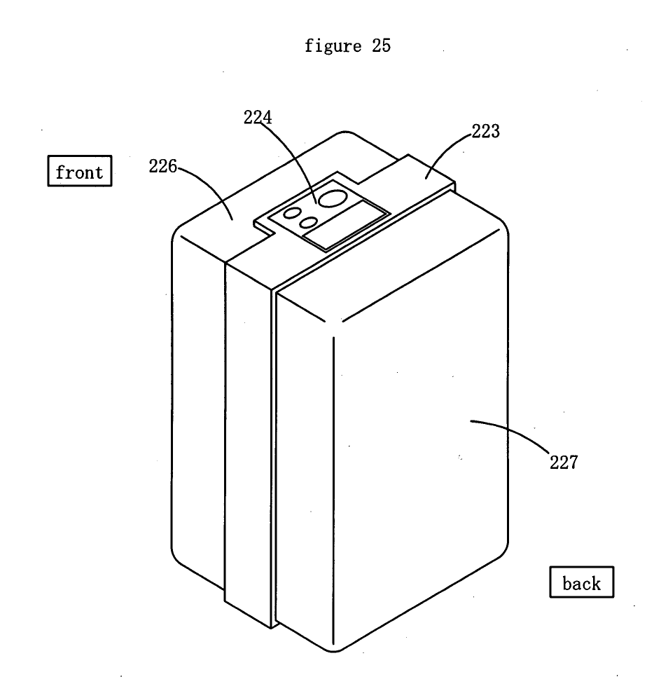

Lastly, an oxygen concentrating device of a third example according to the second embodiment (hereinafter sometimes simply referred to as “oxygen concentrating device of the third example”) will now be described. FIG. 23 is a perspective view illustrating an exploded state of the oxygen concentrating device of the third example. FIG. 24 is a view illustrating the support in the oxygen concentrating device of the third example seen from the back side. FIG. 25 is a perspective view illustrating an outer appearance of the oxygen concentrating device of the third example.

As illustrated in FIG. 23, the oxygen concentrating device of the third example has the solenoid valve block 204, the adsorbing columns 206, 207 and the storing tank 211 arranged on the front side of the support main body 222, and the intake filter 201, the compressor box 228, the cooling fan 229, and the control means 230 arranged on the back side of the support main body 222. Thus, the oxygen concentrating device of the third example has a narrow horizontal width, and the installation area can be reduced. Other configurations in the oxygen concentrating device of the third example are substantially the same as the oxygen concentrating device of the first example, and thus the description will be omitted.

2.4 Application of Oxygen Concentrating Device of Second Embodiment

The oxygen concentrating device of the second embodiment using the cushion material is not only less likely to generate noise, but can be mass produced at low cost, and thus can be used in various applications. Among them, it can be suitably used as a medical oxygen concentrating device used when carrying out oxygen inhalation therapy, and a health oxygen concentrating device used to resolve lack of oxygen after exercise. In particular, it can be suitably used as a medical oxygen concentrating device used to carry out oxygen inhalation therapy at home. Since the oxygen concentrating device of the present invention excels in impact resistance, demand for portable oxygen concentrating device is greatly expected. Furthermore, the oxygen concentrating device of the present invention is not limited to only humans, and may also target on animals.

1. An oxygen concentrating device configured by a plurality of components including an adsorbing column storing an adsorbent capable of selectively adsorbing nitrogen contained in material air, a storing tank for temporarily storing concentrated oxygen gas generated in the adsorbing column, a gas transferring means for transferring the material air, the concentrated oxygen gas or exhaust gas, a solenoid valve for opening, closing or switching a gas flow path connected to the adsorbing column, and a control means for controlling the gas transferring means and/or the solenoid valve; characterized in that
a support made of resin positioning and supporting the plurality of components at predetermined locations, and a plurality of covers made of resin for covering the outer sides of the support are arranged, the support being formed by injection molding.

2. The oxygen concentrating device according to claim 1, further comprising an air take-in port filter for removing dust coexisting in air taken into the inner side of the cover, and a filter cover for covering the outer sides of the air take-in port filter; wherein
said cover has a filter attachment part for removably attaching the filter cover.

3. The oxygen concentrating device according to claim 1, wherein the support is integrally formed by a bottom plate, a pair of side plates upstanding perpendicularly from both side edges of the bottom plate, and a partition plate for partitioning a space sandwiched by the pair of side plates to front and back.

4. The oxygen concentrating device according to claim 1, wherein a fit-in part for positioning and fixing the plurality of covers with respect to the support is arranged on the plurality of covers and the support, respectively.

5. The oxygen concentrating device according to claim 1, wherein the cover is injection molded.

6. The oxygen concentrating device according to claim 1, wherein a material of the support is ABS resin, and a material of the cover is polypropylene.

7. The oxygen concentrating device according to claim 1, wherein casters are arranged at a bottom of the support.

8. The oxygen concentrating device according to claim 1, wherein a reinforcement rib is arranged on the support and/or the cover.

9. The oxygen concentrating device according to claim 1, further comprising an adsorbing column holder for holding the adsorbing column, an adsorbing column holder insertion part for inserting the adsorbing column holder being arranged in the support.

10. The oxygen concentrating device according to claim 1, wherein at least one of the components of the adsorbing column, the gas transferring means, the storing tank, and the solenoid valve is supported by the support by way of a cushion material.

11. The oxygen concentrating device according to claim 10, wherein the cushion material is a sheet-form fiber assembly.

12. The oxygen concentrating device according to claim 11, wherein the cushion material is a non-woven cloth having a thickness of between 2 and 50 mm.

13. The oxygen concentrating device according to claim 10, wherein
the gas transferring means is accommodated in a metal gas transferring means accommodation box; and
the gas transferring means accommodation box is supported by the support by way of the cushion material.

14. The oxygen concentrating device according to claim 13, wherein
the gas transferring means is arranged on a gas flow path on a material air introducing side of the adsorbing column; and
a sound deadening tank is arranged in each of a gas flow path on a material air introducing side of the gas transferring means, a gas flow path on a material air exporting side of the gas transferring means, and a gas flow path on an exhaust gas exporting side of the adsorbing column, at least one of the sound deadening tanks being accommodated in the gas transferring means accommodation box.

15. The oxygen concentrating device according to claim 1, wherein a sound absorbing material is arranged on an inner surface of the cover.

16. The oxygen concentrating device according to claim 1, wherein the support functions as a partition plate for partitioning an inner side of the cover to the front and the back, at least one of the components of the gas transferring means or the solenoid valve being arranged on the back side than the support.

17. The oxygen concentrating device according to claim 1, wherein the support includes a solenoid valve accommodation chamber for accommodating the solenoid valve, a control means accommodation chamber for accommodating the control means, and a gas transferring means accommodation chamber for accommodating the gas transferring means.

18. The oxygen concentrating device according to claim 17, further comprising a cooling fan for transferring cold air on an inner side of the cover; and wherein
the solenoid valve accommodation chamber, the control means accommodation chamber, and the gas transferring means accommodation chamber are communicated; and
the cold air is supplied to the solenoid valve accommodation chamber, the control means accommodation chamber, and the gas transferring means accommodation chamber by the cooling fan.

19. The oxygen concentrating device according to claim 18, wherein the solenoid valve or the control means is arranged on an upstream side in a cold air flowing direction than the cooling fan, and the gas transferring means is arranged on a downstream side in the cold air flowing direction than the cooling fan.

20. An oxygen concentrating device in which a plurality of components including an adsorbing column storing an adsorbent capable of selectively adsorbing nitrogen contained in material air, a storing tank for temporarily storing concentrated oxygen gas generated in the adsorbing column, a gas transferring means for transferring the material air, the concentrated oxygen gas or exhaust gas, a solenoid valve for opening/closing or switching a gas flow path connected to the adsorbing column, and a control means for controlling the gas transferring means and/or the solenoid valve is subjected to wiring and/or piping, and then covered with a cover, characterized in that
an intake filter for removing dust coexisting in the material air supplied to the adsorbing column, and a filter holder for holding the intake filter are arranged, an opening A for inserting and removing the filter holder being formed in the cover.

21. The oxygen concentrating device according to claim 20, further comprising a support for positioning and supporting the plurality of components at predetermined locations on an inner side of the cover, and wherein
the support has an opening B, and the filter holder is inserted and removed from the outer side of the cover through the opening A and the opening B.
